(19) United States
(12) Patent Application Publication
(10) Pub. No.: US 2024/0319323 A1
(43) Pub. Date: Sep. 26, 2024

(54) RADAR APPARATUS, SYSTEM, AND METHOD

(71) Applicant: Intel Corporation, Santa Clara, CA (US)

(72) Inventors: Oren Shalita, Tel-Aviv (IL); Ophir Shabtay, Tsofit (IL); Yaniv Avital, Mevasseret Zion (IL)

(73) Assignee: Intel Corporation, Santa Clara, CA (US)

(21) Appl. No.: 18/574,716

(22) PCT Filed: Dec. 21, 2021
(86) PCT No.: PCT/US2021/064686

§ 371 Date: Dec. 27, 2023

(51) Int. Cl. G01S 7/02; G01S 13/89; G01S 13/931

(52) U.S. Cl. CPC G01S 7/023; G01S 7/0232; G01S 7/0235; G01S 7/0236; G01S 13/89; G01S 13/931

(57) ABSTRACT

Some demonstrative aspects include radar apparatuses, devices, systems and methods. In one example, a radar system may include one or more radar devices. For example, a radar device may include one or more Transmit (Tx) antennas to transmit radar Tx signals, one or more Receive (Rx) antennas to receive radar Rx signals, and a processor to generate radar information based on the radar Rx signals. In one example, the radar system may be implemented as part of a vehicle. In other aspects, the radar system may include any other additional or alternative elements and/or may be implemented as part of any other device or system.

### TECHNICAL FIELD

Aspects described herein generally relate to radar devices and/or systems.

### BACKGROUND

Various types of devices and systems, for example, assistance and/or autonomous systems, e.g., to be used in vehicles, airplanes and robots, may be configured to perceive and navigate through their environment using sensor data of one or more sensor types.

Conventionally, autonomous perception relies heavily on light-based sensors, such as image sensors, e.g., cameras, and/or Light Detection and Ranging (LIDAR) sensors. Such light-based sensors may perform poorly under certain conditions, such as, conditions of poor visibility, or in certain inclement weather conditions, e.g., rain, snow, hail, or other forms of precipitation, thereby limiting their usefulness or reliability.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10 is a schematic illustration of a processor apparatus, in accordance with some demonstrative aspects.

FIG. 11 is a schematic illustration of a processing scheme to generate four dimensional (4D) Point Cloud (PC) radar information, in accordance with some demonstrative aspects.

FIG. 12 is a schematic illustration of a radar processing scheme to balance between an interference level and a reduced 4D PC, in accordance with some demonstrative aspects.

FIG. 13 is a schematic flow-chart illustration of a method of generating 4D PC radar information, in accordance with some demonstrative aspects.

FIG. 14 is a schematic illustration of a processor apparatus, in accordance with some demonstrative aspects.

FIG. 15 is a schematic illustration of a radar processing scheme to process radar communications, in accordance with some demonstrative aspects.

FIG. 16 is a schematic illustration of a range response, to demonstrate a technical problem, which may be addressed in accordance with some demonstrative aspects.

FIG. 17 is a schematic illustration of a range response based on Rx radar signals received by a radar device, in accordance with some demonstrative aspects.

FIG. 18 is a schematic illustration of a range-Doppler response based on Rx radar signals received by a radar device, in accordance with some demonstrative aspects.

FIG. 19 is a schematic flow-chart illustration of a method of determining a setting of one or more Tx parameters for transmitting radar Tx signals, in accordance with some demonstrative aspects.

FIG. 20 is a schematic illustration of a processor apparatus, in accordance with some demonstrative aspects.

FIG. 21 is a schematic illustration of illustrates a radar processing scheme to process radar Rx data corresponding to radar Rx signals received by an antenna array, in accordance with some demonstrative aspects

FIG. 22 is a schematic illustration of a plurality of AoA spectrums, in accordance with some demonstrative aspects.

FIG. 23 is a schematic flow-chart illustration of a method of detecting whether radar Rx signals are subject to an interference signal, in accordance with some demonstrative aspects.

FIG. 24 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, aspect, or design described herein as “exemplary” or “demonstrative” is not necessarily to be construed as preferred or advantageous over other aspects, aspects, or designs.

References to “one aspect”, “an aspect”, “demonstrative aspect”, “various aspects” “one aspect”, “an aspect”, “demonstrative aspect”, “various aspects” etc., indicate that the aspect(s) and/or aspects so described may include a particular feature, structure, or characteristic, but not every aspect or aspect necessarily includes the particular feature, structure, or characteristic. Further, repeated use of the phrase “in one aspect” or “in one aspect” does not necessarily refer to the same aspect or aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation). In addition, systems described herein may be used for assistance purposes in vehicles, e.g., to provide information to a driver and/or other occupants of a vehicle.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHz, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, the circuitry may be implemented in, or functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

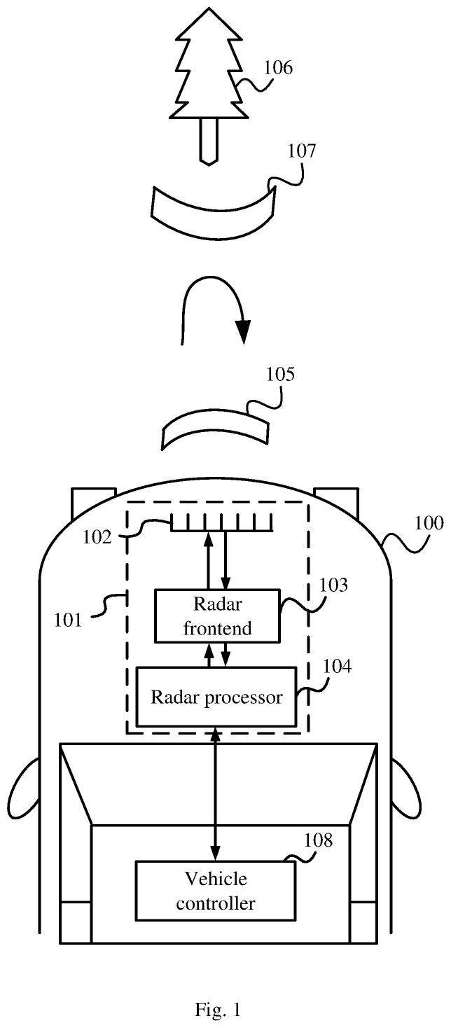

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar devices 101. For example, radar device 101 may be implemented by a plurality of radar units, which may be at a plurality of locations, e.g., around vehicle 100. In other aspects, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include other vehicles; pedestrians; traffic signs; traffic lights; roads, road elements, e.g., a pavement-road meeting, an edge line; a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below. In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and a one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identity a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

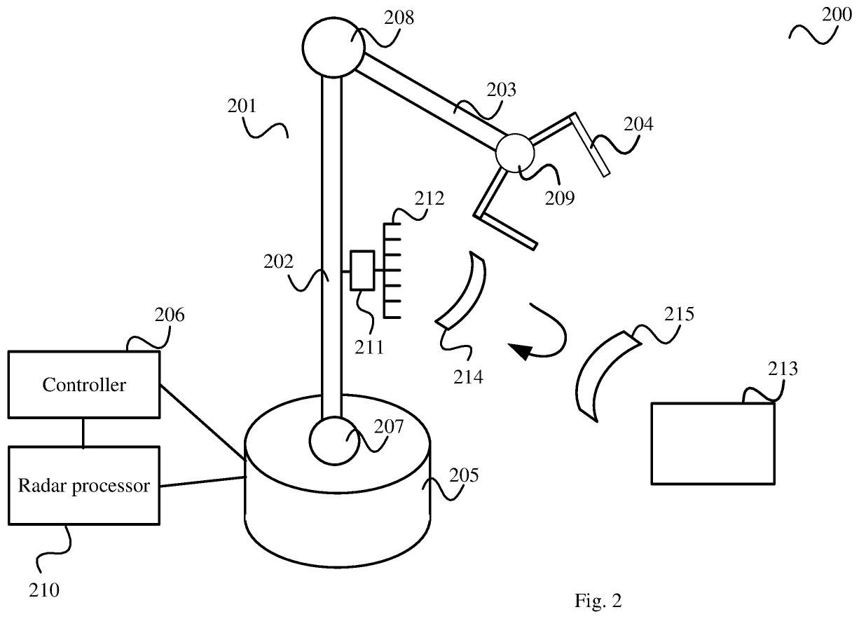

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e. actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201. For example, a location and/or orientation of a radar signal transmission source and/or a radar signal reception sink may be physically moved within the reach of the robot arm. In another example, the source and/or the sink of radar signals may be attached to a non-movable, fixed part of the robot arm, e.g., a base of the robot arm or a stationary part of the arm, or installed in an environment, e.g., in a suitable vicinity of robot arm. In another example, the robot may be an autonomous robot with a robot arm.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

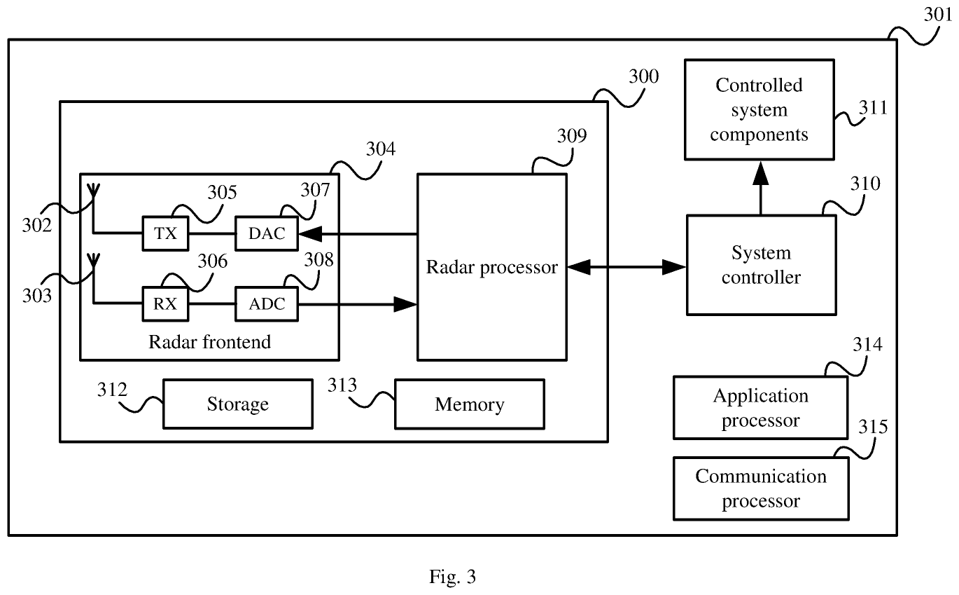

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may configured to perform one or more operations and/or functionalities of, the devices or systems described above with reference to FIG. 1 an/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, system controller 310 may be configured to control one or more controlled system components 311 of the system 301, e.g. a motor, a brake, steering, and the like, e.g. by one or more corresponding actuators.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a continuous wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated continuous wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

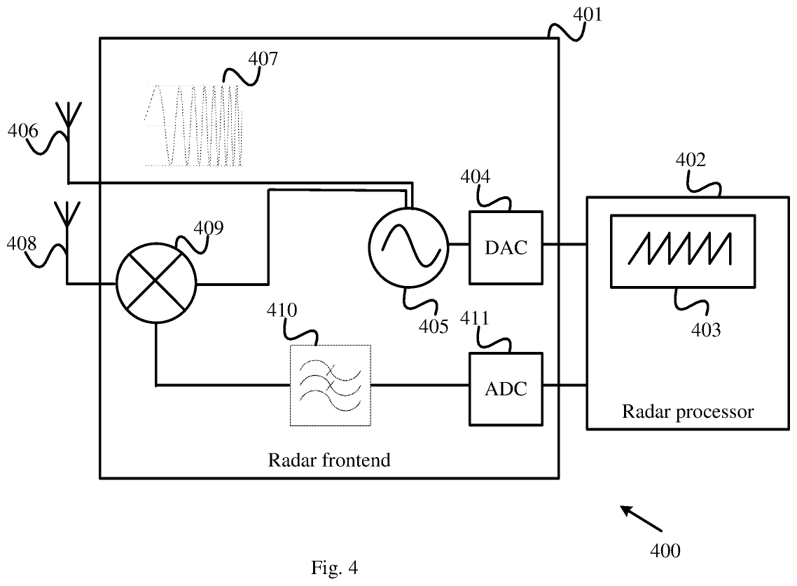

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

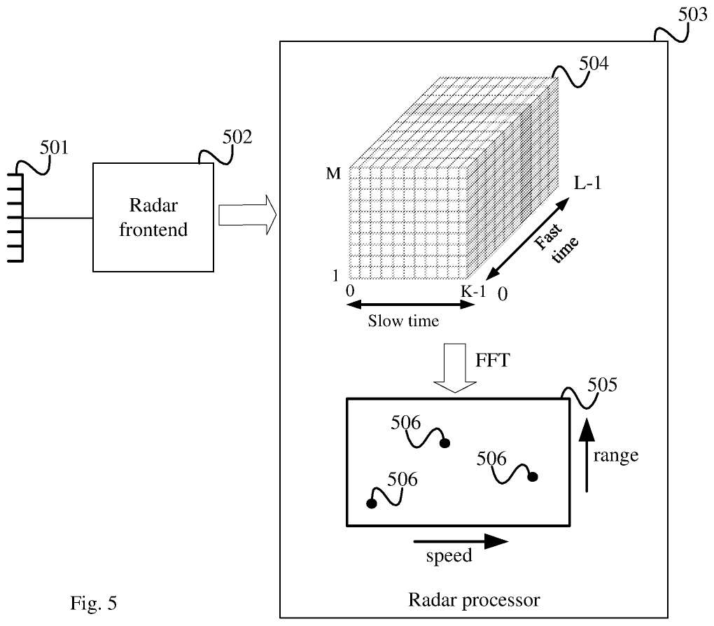

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time”-direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time”-direction of the data cube 504.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

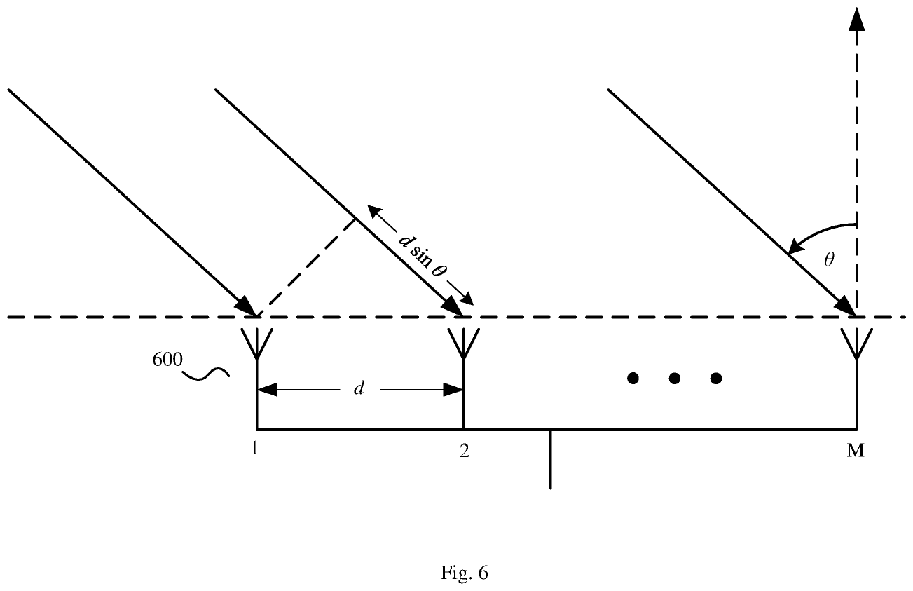

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array. In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Δφ, between two antennas of the receive antenna array 600 may be determined, e.g., as follows:

$$Δφ = \frac{2 π}{λ} \cdot d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

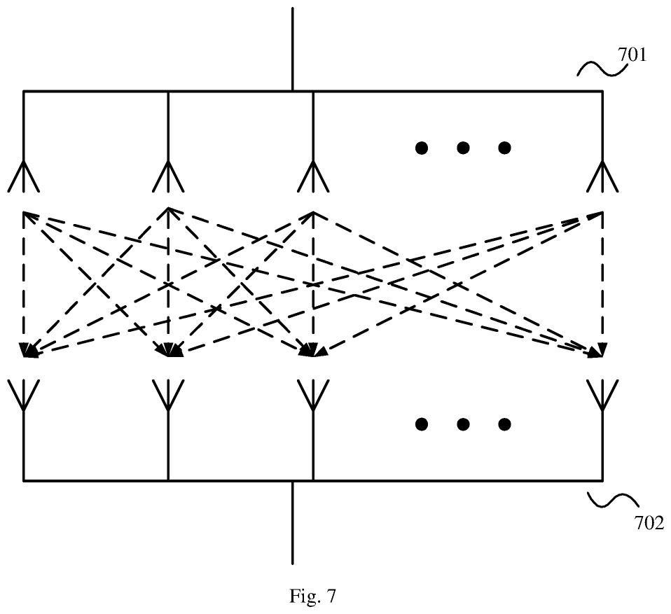

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

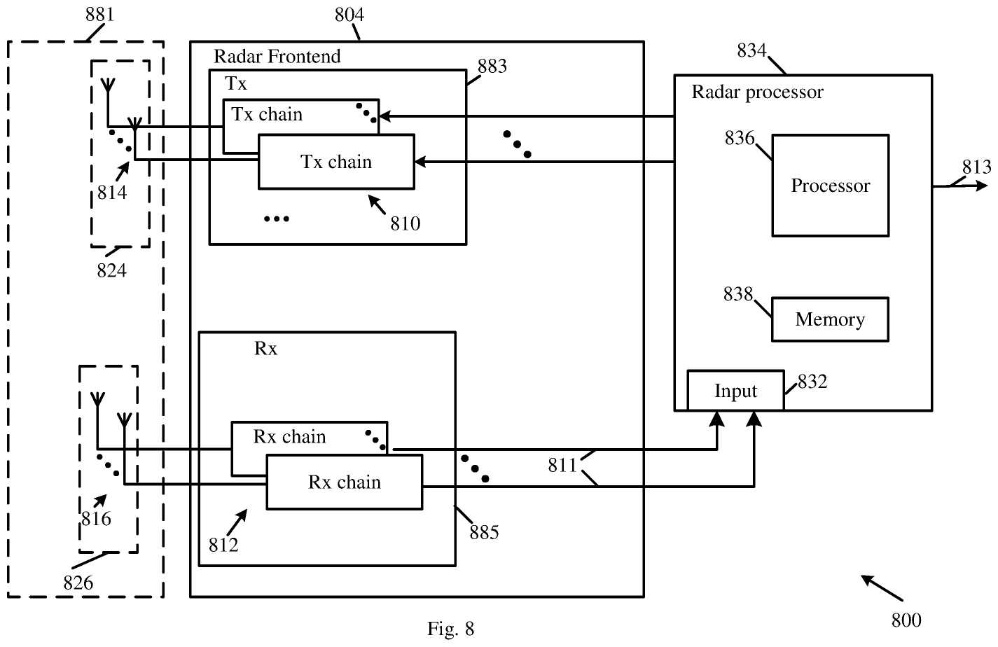

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design. In other aspects, any other form, shape and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data, e.g., as described below. In one example, the range information and/or Doppler information may be determined based on a Cross-Correlation (XCORR) operation, which may be applied to the radar Rx data. Any other additional or alternative operation, algorithm and/or procedure may be utilized to generate the range information and/or Doppler information.

In some demonstrative aspects, memory 838 may be configured to store AoA information, which maybe generated by processor 836, for example, based on the radar Rx data, the range information and/or Doppler information, e.g., as described below. In one example, the AoA information may be determined based on an AoA estimation algorithm. Any other additional or alternative operation, algorithm and/or procedure may be utilized to generate the AoA information.

In some demonstrative aspects, radar processor 834 may be configured to generate the radar information 813 including one or more of range information, Doppler information, and/or AoA information, e.g., as described below.

In some demonstrative aspects, the radar information 813 may include Point Cloud 1 (PC1) information, for example, including raw point cloud estimations, e.g., Range, Radial Velocity, Azimuth and/or Elevation.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

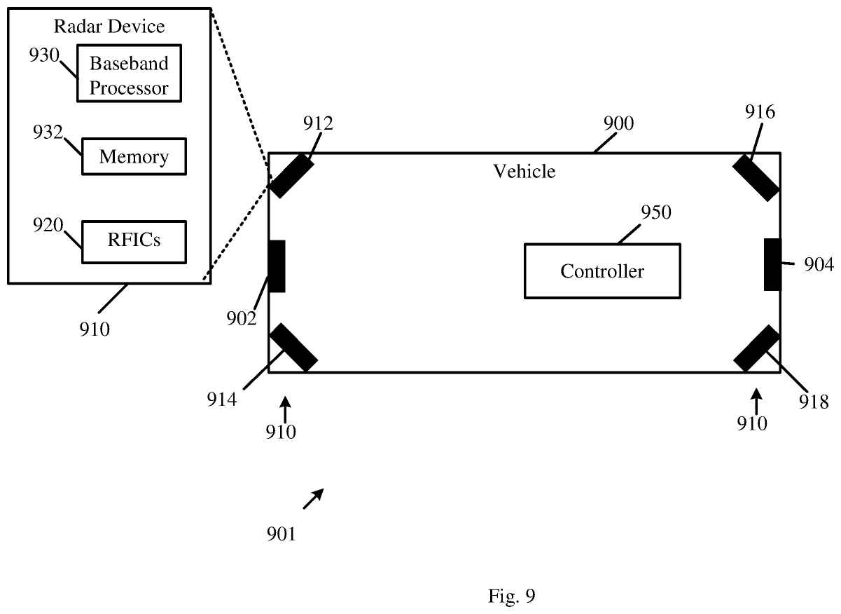

Reference is made to FIG. 9, which schematically illustrates a radar system 901 including a plurality of radar devices 910 implemented in a vehicle 900, in accordance with some demonstrative aspects.

In some demonstrative aspects, as shown in FIG. 9, the plurality of radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of radar devices 910 may include, for example, six radar devices 910, e.g., as described below.

In some demonstrative aspects, the plurality of radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of radar devices 910 may include any other number of radar devices 910, e.g., less than six radar devices or more than six radar devices.

In other aspects, the plurality of radar devices 910 may be positioned at any other locations and/or according to any other arrangement, which may support radar sensing at any other field of view around vehicle 900, e.g., 360-degrees radar sensing or radar sensing of any other field of view.

For example, the plurality of radar devices 910 may be positioned at one or more locations, e.g., at one or more heights, for example, at different height locations, e.g., at a bumper height, a headlight height, a Facia center/top corners/roof height, and/or any other location.

In some demonstrative aspects, as shown in FIG. 9, vehicle 900 may include a first radar device 902, e.g., a front radar device, at a front-side of vehicle 900.

In some demonstrative aspects, as shown in FIG. 9, vehicle 900 may include a second radar device 904, e.g., a back radar device, at a back-side of vehicle 900.

In some demonstrative aspects, as shown in FIG. 9, vehicle 900 may include one or more of radar devices at one or more respective corners of vehicle 900. For example, vehicle 900 may include a first corner radar device 912 at a first corner of vehicle 900, a second corner radar device 914 at a second corner of vehicle 900, a third corner radar device 916 at a third corner of vehicle 900, and/or a fourth corner radar device 918 at a fourth corner of vehicle 900.

In some demonstrative aspects, vehicle 900 may include one, some, or all, of the plurality of radar devices 910 shown in FIG. 9. For example, vehicle 900 may include the front radar device 902 and/or back radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the radar devices 910.

In some demonstrative aspects, at least part of the functionality of radar system controller 950 may be implemented by a dedicated controller, e.g., a dedicated system controller or central controller, which may be separate from the radar devices 910, and may be configured to control some or all of the radar devices 910.

In some demonstrative aspects, at least part of the functionality of radar system controller 950 may be implemented as part of at least one radar device 910.

In one example, at least part of the functionality of system controller 950 may be implemented, e.g., in a centralized manner, for example, as part of a single radar device 910 of the plurality of radar devices 910.

In another example, at least part of the functionality of radar system controller 950 may be implemented, e.g., in a distributed manner, for example, as part of two or more radar device 910 of the plurality of radar devices 910. For example, at least part of the functionality of system controller 950 may be distributed between some or all of the radar devices 910.

In some demonstrative aspects, at least part of the functionality of radar system controller 950 may be implemented by a radar processor of at least one of the radar devices 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, a radar device 910 of the plurality of radar devices 910, e.g., each radar device 910, may include a baseband processor 930 (also referred to as a “Baseband Processing Unit (BPU)”), which may be configured to control communication of radar signals by the radar device 910, and/or to process radar signals communicated by the radar device 910. For example, baseband processor 930 may include one or more elements of radar processor 834 (FIG. 8), and/or may perform one or more operations and/or functionalities of radar processor 834 (FIG. 8).

In some demonstrative aspects, baseband processor 930 may include one or more components and/or elements configured for digital processing of radar signals communicated by the radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, radar device 910 may include a memory 932, which may be configured to store data processed by, and/or to be processed by, baseband processor 910. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In some demonstrative aspects, as shown in FIG. 9, radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, there may be a need to provide a technical solution to mitigate radio interference between radar devices, for example, radio interference at radar devices of vehicle 900, which may be caused by radar communications from other radar devices, e.g., of other vehicles, and/or one or more other radar communication sources, e.g., as described below.

In some demonstrative aspects, a number of vehicles equipped with radar devices may be expected to grow, for example, as importance of a radar sensor as a major sensor increases, e.g., for Advanced Driver-Assistance Systems (ADAS) and/or autonomous driving.

In some demonstrative aspects, radio interference between radar devices may be expected to grow as well, e.g., as a result of the increase in the number of autonomous vehicles utilizing radar devices.

In some demonstrative aspects, radio interference between radar devices may affect the performance of the radar devices, for example, in terms of a degraded radar effective range, reduced probability of detections, an increase in a number of false alarm detections, and/or any other effects on the radar performance.

In some demonstrative aspects, for example, in some use cases, scenarios, and/or implementations, there may be one or more disadvantages, inefficiencies, and/or technical problems in implementing mitigation methods including interference detection and/or mitigation with respect to interference caused by a single radar unit. For example, these mitigation methods may not be suitable for providing a solution to consider compute resources and/or issues of product implementation, which may degrade an accuracy and/or effectivity of the mitigation methods.

In some demonstrative aspects, for example, in some use cases, scenarios, and/or implementations, there may be one or more disadvantages, inefficiencies, and/or technical problems in implementing mitigation methods including interference detection and/or mitigation based on hoping between radar resources, e.g., which may suffer less interference. For example, these mitigation methods may not provide a solution for definitive mitigation, for example, since the interference level may be assumed to be non-stationary, e.g., as current radar frame measurements may not predict the situation in the next radar frame measurements.

In some demonstrative aspects, a radar device, e.g., radar device 910, may be configured to mitigate interference in an environment of the radar device 910, e.g., an environment of vehicle 900, for example, according to a radar processing scheme, e.g. a radar-resource balancing scheme, e.g., as described below.

In some demonstrative aspects, the radar processing scheme may be configured to improve processing gain and/or to mitigate interference, for example, based on a narrower four-dimension (4D) Point Cloud (PC) (also referred to as a “reduced 4D PC scope”), for example, which may be reduced compared to a full 4D PC (also referred to as a “4D PC scope”), e.g., as described below.

In some demonstrative aspects, the 4D PC scope may include a set of detections in a 4D point cloud grid including, for example, radial velocity, and positions, for example, 3D positions, e.g., in polar coordinates and/or any other coordinates.

In some demonstrative aspects, the full 4D PC scope may include a full 4D PC scope supported by a radar device, e.g., radar device 910.

In some demonstrative aspects, a PC dimension of the 4D PC scope, e.g., each PC dimension of the 4D PC scope, may have a range of values, e.g., as described below.

In one example, the full 4D PC scope of radar device 910 may include a full range of values in each PC dimension of the 4D PC scope supported by the radar device 910.

In some demonstrative aspects, the reduced 4D PC scope may include a partial range of values in one, some, or all PC dimensions of the reduced 4D PC scope, e.g., as described below.

In one example, the reduced 4D PC scope implemented by radar device 910 may include at least one reduced range of values for at least one dimension of the of the 4D PC scope supported by the radar device 910. For example, the reduced range of values may include only some of the values in the full range of values for the PC dimension, which may be supported by the radar device 910.

In some demonstrative aspects, the reduced 4D PC scope may be configured, for example, to mitigate interference, for example, to minimize damage of interference, e.g., as described below.

In some demonstrative aspects, the radar processing scheme may be implemented to provide a technical solution to facilitate creation of a narrower 4D PC scope, e.g., as described below.

In some demonstrative aspects, the radar processing scheme may be implemented to provide a technical solution to facilitate creation of an associated interference mitigation gain, for example, as a result of the narrower 4D PC scope, e.g., as described below.

In some demonstrative aspects, the radar processing scheme may be implemented to provide a technical solution, which may support a controlled way to deal with interference, for example, while managing and/or clearly defining a trade-off between a Signal to Interference Noise Ratio (SINR) and a size of the reduced 4D PC scope, e.g., as described below.

In some demonstrative aspects, the radar processing scheme may be implemented to provide a technical solution, which may provide a managed trade-off between the SINR, mitigation capabilities and/or estimated mitigation capabilities, and the reduced 4D PC scope, e.g., as described below.

In some demonstrative aspects, the radar processing scheme may be implemented to provide a technical solution, which may support statistical analysis of an interference level, e.g., which may be related to radar density. For example, a level of trade-off between the SINR and the reduced 4D PC scope may be determined, for example, based on the statistical analysis, and/or based on an estimated mitigation capability of a radar frame, e.g., as described below.

In some demonstrative aspects, the radar processing scheme may be implemented to provide a technical solution, which may be practical and applicable in a real world, e.g., as described below.

In some demonstrative aspects, the radar processing scheme may be implemented to provide a technical solution, which may be robust to a dynamic and/or non-stationary nature of interference from many neighbor vehicles in the vicinity of a vehicular radar device, e.g., as described below.

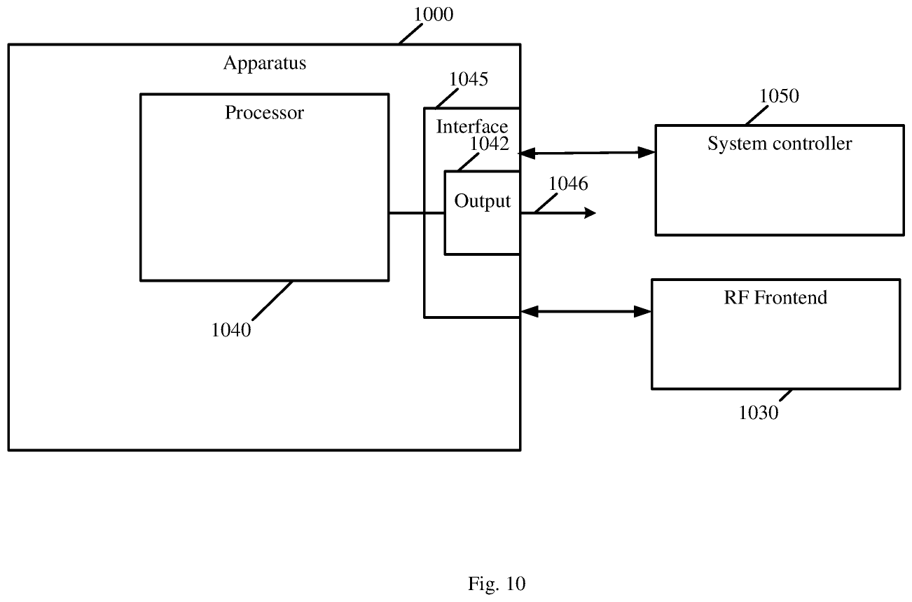

Reference is made to FIG. 10, which schematically illustrates a processor apparatus 1000, in accordance with some demonstrative aspects.

In some demonstrative aspects, apparatus 1000 may be configured to implement and/or to support a radar processing scheme, e.g., as described below.

In some demonstrative aspects, apparatus 1000 may be implemented, for example, as part of a radar device, e.g., a radar device 910 (FIG. 9).

In some demonstrative aspects, apparatus 1000 may be implemented, for example, as part of a controller, e.g., controller 950 (FIG. 9).

In some demonstrative aspects, apparatus 1000 may be implemented, for example, as part of a radar processor, e.g., radar processor 834 (FIG. 8), and/or BB processor 930 (FIG. 9).

In some demonstrative aspects, apparatus 1000 may include an interface 1050 configured to interconnect and/or interface between apparatus 1000 and one or more other devices, components and/or elements of radar device 910 (FIG. 9), and/or radar system 901 (FIG. 9), e.g., as described below.

In some demonstrative aspects, interface 1050 may interconnect and/or interface between apparatus 1000 and a system controller 1050. For example, system controller 1050 may include one or more elements of controller 950 (FIG. 9) and/or vehicle controller 108 (FIG. 1), and/or may perform one or more operations and/or functionalities of controller 950 (FIG. 9) and/or vehicle controller 108 (FIG. 1).

In some demonstrative aspects, interface 1050 may interconnect and/or interface between apparatus 1000 and at least one RF frontend 1030. For example, RF frontend 1030 may include one or more elements of RFICs 920 (FIG. 9), and/or may perform one or more operations and/or functionalities of RFICs 920 (FIG. 9).

In some demonstrative aspects, apparatus 1000 may include a processor 1040 configured to generate and/or process radar information for a radar device, for example, radar device 91—(FIG. 9), e.g., as described below. For example, radar processor 834 (FIG. 8) may include one or more elements of processor 1040, and/or may perform one or more operations and/or functionalities of processor 1040; BB processor 930 (FIG. 9) may include one or more elements of processor 1040, and/or may perform one or more operations and/or functionalities of processor 1040; and/or controller 950 (FIG. 9) may include one or more elements of processor 1040, and/or may perform one or more operations and/or functionalities of processor 1040.

In some demonstrative aspects, processor 1040 may include, or may be implemented, partially or entirely, by circuitry and/or logic, e.g., one or more processors including circuitry and/or logic, memory circuitry and/or logic. Additionally or alternatively, one or more functionalities of processor 1040 may be implemented by logic, which may be executed by a machine and/or one or more processors, e.g., as described below.

In some demonstrative aspects, processor 1040 may be configured to identify a value of an interference-based parameter corresponding to an interference level in an environment of radar device, e.g., radar device 910 (FIG. 9). In one example, the interference-based parameter corresponding to an interference level in a vicinity, e.g., a far vicinity and/or a near vicinity, of vehicle 900 (FIG. 9), e.g., as described below.

In some demonstrative aspects, processor 1040 may be configured to determine a PC dimension size of least one dimension of a 4D PC, for example, based on the value of the interference-based parameter, e.g., as described below.

In some demonstrative aspects, processor 1040 may be configured to generate 4D PC radar information 1046, for example, according to the PC dimension size, e.g., as described below.

In some demonstrative aspects, the 4D PC radar information 1046 may be based on radar data corresponding to radar signals communicated by the radar device 910 (FIG. 9), e.g., as described below.

In some demonstrative aspects, radar device 910 (FIG. 9) may be configured to communicate the radar signals, and/or to generate radar information, for example, based on the 4D PC radar information 1046.

In some demonstrative aspects, processor 1040 may include an output 1042 to provide the 4D PC radar information 1046, e.g., as described below.

In one example, processor 1040 provide the 4D PC radar information 1046, for example, to system controller 1050 and/or to any other component or element, for example, via output 1042 and/or interface 1045.

In some demonstrative aspects, the interference-based parameter may be based on an SINR estimation corresponding to a radar radio resource for communication of radar signals, e.g., as described below.

In some demonstrative aspects, the interference-based parameter may be based on a radar interference mitigation capability and/or an estimation of an interference mitigation capability e.g., as described below.

In other aspects, the interference-based parameter may be based on any other additional or alternative parameter or attribute.

In other aspects, any other interference-based parameter may be implemented.

In some demonstrative aspects, processor 1040 may be configured to identify a selected radio resource from a plurality of radio resources to communicate the radar signals, e.g., as described below.

In some demonstrative aspects, a radar resource may include a frequency band, a frame duration, a frame start time, a code, a polarization, a spatial distance, and/or any radar, radio, and/or computing resources. In one example, the radio resource may be configured to enable orthogonal or close to orthogonal transmission and reception of radio waves.

In some demonstrative aspects, processor 1040 may be configured to determine the PC dimension size, for example, based on the value of the interference-based parameter corresponding to the selected radio resource, e.g., as described below.

In some demonstrative aspects, the PC dimension size of the dimension of the 4D PC may include a reduced PC dimension size, which is less than a supported size of the dimension of the 4D PC, which may be supported, for example, by radar device 910 (FIG. 9), e.g., as described below.

In some demonstrative aspects, the reduced PC dimension size may define a selected sub-range of dimension values from a range of dimension values in the dimension of the 4D PC, e.g., as described below.

In some demonstrative aspects, processor 1040 may be configured to generate the 4D PC radar information 1046 with respect to the sub-range of dimension values, e.g., as described below.

In some demonstrative aspects, the PC dimension size may include a size of an Azimuth (Az) Field of View (FoV) in the 4D PC, e.g., as described below.

In some demonstrative aspects, the PC dimension size may include a size of an Elevation (El) FoV in the 4D PC, e.g., as described below.

In some demonstrative aspects, the PC dimension size may include a size of a range dimension in the 4D PC, e.g., as described below.

In some demonstrative aspects, the PC dimension size may include a size of a Doppler dimension in the 4D PC, e.g., as described below.

In other aspects, the PC dimension size may include a size of any other additional or alternative dimension of the PC.

In some demonstrative aspects, processor 1040 may be configured to determine a first PC dimension size, for example, based on a first value of the interference-based parameter, e.g., as described below.

In some demonstrative aspects, processor 1040 may be configured to generate first 4D PC radar information according to the first PC dimension size, e.g., as described below.

In some demonstrative aspects, processor 1040 may be configured to determine a second PC dimension size, for example, based on a second value of the interference-based parameter, e.g., as described below.

In some demonstrative aspects, processor 1040 may be configured to generate second 4D PC radar information according to the second PC dimension size, e.g., as described below.

In some demonstrative aspects, the first value of the interference-based parameter may be different from the second value of the interference-based parameter, e.g., as described below.

In some demonstrative aspects, the first PC dimension size may define a first sub-range of dimension values from a range of dimension values in the dimension of the 4D PC, and/or the second PC dimension size may define a second sub-range of dimension values from the range of dimension values in the dimension of the 4D PC, e.g., as described below.

In some demonstrative aspects, the second sub-range of dimension values may be different from the first sub-range of dimension values, e.g., as described below.

In some demonstrative aspects, the first value of the interference-based parameter may be greater than the second value of the interference-based parameter, and/or the second PC dimension size may be less than the first PC dimension size, e.g., as described below.

In some demonstrative aspects, processor 1040 may be configured to determine a radar scheme based on the value of the interference-based parameter, e.g., as described below.

In some demonstrative aspects, the radar scheme may be configured to define a configuration of the radar device, e.g., radar device 910 (FIG. 9), to generate the 4D PC radar information 1046, for example, according to the PC dimension size, e.g., as described below.

In some demonstrative aspects, processor 1040 may be configured to determine a selected radar scheme from a plurality of radar schemes, for example, based on the value of the interference-based parameter, e.g., as described below.

In some demonstrative aspects, the selected radar scheme may correspond to the PC dimension size, e.g., as described below.

In some demonstrative aspects, the radar scheme may include a radar communication scheme to communicate the radar signals, e.g., as described below.

In some demonstrative aspects, the radar communication scheme may be according to the PC dimension size, e.g., as described below.

In some demonstrative aspects, the radar communication scheme may include a radar Tx scheme to configure transmission of radar Tx signals by the radar device, e.g., radar device 910 (FIG. 9), e.g., as described below.

In one example, processor 1040 may be configured to control transmission of radar Tx signals by RF frontend 1030, for example, based on a radar communication scheme, which may be configured according to the PC dimension size, e.g., as described below.

In some demonstrative aspects, the radar Tx scheme may include a Tx beamforming scheme, e.g., as described below.

In one example, the Tx beamforming scheme may configure Tx beamforming to increase energy on a target, for example, by focusing a spatial power distribution to a subset of a supported field of view.

In another example, the Tx beamforming scheme may configure Tx beamforming to reduce spatial power, for example, in one or more non-focused areas of the supported field of view.

In some demonstrative aspects, there may be a tradeoff between a PC scope and an interference level, e.g., SINR, for example, when implementing a Tx beamforming scheme.

In some demonstrative aspects, the Tx beamforming scheme may be configured to increase the energy on the target, for example, based on a ratio between a full/supported FoV, e.g., an elevation FoV and/or an azimuth FoV, and a reduced FoV, e.g., a reduced elevation FoV and/or a reduced azimuth FoV, e.g., as follows:

$$- 10 * log 10 ( [ reduced El FoV ] / [ El FoV ] ) - 10 * log 10 ( [ reduced Az FoV ] / [ Az FoV ] ) \qquad ( 1 )$$

In some demonstrative aspects, the radar Tx scheme may include a Tx frequency bandwidth (BW) for transmission of the radar Tx signals, e.g., as described below.

In some demonstrative aspects, there may be a tradeoff between a PC scope and an interference level, e.g., SINR, for example, when implementing a reduced Tx frequency BW scheme.

In one example, the Tx frequency BW scheme may configure the Tx frequency BW, for example, such that a Tx power of RF frontend 1030 may be focused on a narrower set of frequencies, and, therefore, a power density, e.g., per Hz, may be higher. For example this focused power may result in a degradation in range resolution, for example, as the range resolution may be directly associated with the Tx frequency BW.

In some demonstrative aspects, the Tx frequency BW scheme may configure the Tx frequency BW, for example, such that an increase in the power density per Hz may be based, for example, on a ratio between a reduced Tx frequency BW and a maximal/required Tx frequency BW, e.g., as follows:

$$- 10 * log 10 ( [ reduced Frequency Band ] / [ Max or required Frequency band ] ) \qquad ( 2 )$$

For example, the power density per Hz may be changed, for example, by moving between radar modes, for example, Short Range Radar (SRR), e.g., for high BW, Mid-Range Radar (MRR), e.g., for mid BW, and/or Long Range Radar (LRR), e.g., for lower BW, e.g., as follows:

$$10 * log 10 ( [ BW ( MRR ) ] / [ BW ( LRR ) ] ) = 3 dB \qquad ( 3 )$$

$$10 * log 10 ( [ BW ( SRR ) ] / [ BW ( MRR ) ] ) = 6 dB$$

$$10 * log 10 ( [ BW ( SRR ) ] / [ BW ( LRR ) ] ) = 9 dB$$

In some demonstrative aspects, there may be a tradeoff between a PC scope and an interference level, e.g., SINR, for example, according to a configuration of radar Tx pulses, e.g., as described below.

In some demonstrative aspects, processor 1040 may be configured to determine the radar Tx scheme to include a Tx pulse duration of the radar Tx signals, and/or a count of Tx pulses per radar frame, e.g., as described below.

In some demonstrative aspects, the Tx pulse duration of the radar Tx signals communicated by RF frontend 1030 may be increased, for example, to increase time on a target.

In one example, in slow driving condition, it may be beneficial to increase an illumination time of the radar transmitter, for example, by processing multi-shots, e.g., multiple radar frames, and/or by increasing the Tx pulse duration, e.g., in each frame, of the radar Tx signals.

In some demonstrative aspects, increasing the Tx pulse duration may have some penalty, e.g., in the sense of a required slow movement of the radar device, and/or larger range migrations, e.g., resulting in higher processing capacity and/or more artifacts. For example, increasing the Tx pulse duration of the radar Tx signals may be a suitable method for a traffic jam scenario.

In some demonstrative aspects, increasing the Tx pulse duration of the radar Tx signals from an original Tx pulse duration to a longer Tx pulse duration may result in an increase in a reflected power, for example, based on a ratio between the original Tx pulse duration and the longer Tx pulse duration, e.g., as follows:

$$10 * log 10 ( [ Longer Frame length ] / [ Original Frame length ] ) \qquad ( 4 )$$

In some demonstrative aspects, increasing the Tx pulse duration may result in a longer Pulse Repetition Interval (PRI).

In some demonstrative aspects, a penalty of increasing the Tx pulse duration may be a reduced Max un-ambiguous Doppler, heat dissipation, and/or larger power consumption.

In some demonstrative aspects, increasing the Tx pulse duration may result in a longer code per pulse, e.g., chirp, which may prevent appearance of ghost peaks, and/or may smear the interference energy, e.g., all over a Range-Doppler space.

In some demonstrative aspects, processor 1040 may be configured to determine the radar communication scheme by determining a radar frame rate according to the PC dimension size, e.g., as described below.

In some demonstrative aspects, the radar frame rate may configure a rate of radar frames to be communicated by the RF frontend 1030, e.g., as described below.

In some demonstrative aspects, reducing the radar frame rate may allow to free processing power of computing resources, which may be allocated for processing of the radar frame.

In some demonstrative aspects, this processing power may be utilized, for example, to perform one or more operations to mitigate interference.

In one example, reducing the radar frame rate may support use of one or more super resolution algorithms, e.g., Minimum Variance Distortionless Response (MVDR), Minimum Power Distortionless Response (MPDR), MUltiple SIgnal Classification (MUSIC), or the like, e.g., including adaptive filtering methods, for example, to set up nulls on interferers.

In some demonstrative aspects, a processing gain resulting from reducing of the radar frame rate may depend on an array geometry, a number of elements in the radar antenna, the radar scene itself, a number of interferers, relative Doppler shifts, and/or any other additional and/or alternative parameters. For example, a processing gain resulting from reducing of the radar frame rate may be high, e.g., even more than 30 db.

In one example, estimation of the processing gain may be based on tables, which may consider a radar design and scene parameters, e.g., to report a premeasured gain, one or more heuristics to determine the processing gain, SINR and gain estimation measurements from previous frames, an Al based gain estimation, and/or any other alternative and/or additional parameters.

In some demonstrative aspects, processor 1040 may be configured to determine the radar communication scheme be configuring a radar range to configure a maximal radar detection range, e.g., as described below.

In some demonstrative aspects, reducing the radar range may increase an SNR of received signals. For example, the closer the reflection from a target, the higher the SNR.

In some demonstrative aspects, the processing gain from reducing the radar range may be based on a ratio between the maximal radar range and the reduced radar range, for example, considering that a received power may be according to 1/R\hat{ }4, e.g., as follows:

$$40 * log 10 ( [ Original Max Range ] / [ Shorter Max Range ] ) \qquad ( 5 )$$

In one example, reducing the maximal radar range by half may be associated with an increase of approximately 12 dB in SINR.

In some demonstrative aspects, processor 1040 may be configured to determine the radar scheme to include a radar processing scheme to process the radar data corresponding to radar signals communicated by the RF frontend 1030, e.g., as described below.

In one example, processor 1040 may configure processing of radar signals received by RF frontend 1030 according to the PC dimension size, e.g., as described below.

In some demonstrative aspects, processor 1040 may be configured to determine the radar processing scheme configured to reduce post processing capacity for post processing of radar data.

In one example, the post processing of the radar data may include temporal processing of radar frames.

In another example, the post processing of the radar data may optionally include clustering, tracking, applying bounding boxes, and/or classification of targets, for example, to determine drivable space estimation, and/or any other post processing operations.

In some demonstrative aspects, reducing the post processing capacity may enable, for example, to increase compute power for interference mitigation.

In some demonstrative aspects, one or more post-processing compute resources may be used for interference mitigation.

In one example, the post processing may be reduced to a very simple low-compute scheme, which may be handled by system controller 1050, e.g., assuming system controller 1050 is capable of handling this lower quality of post processing, or that the system controller 1050 may assume the post processing task.

In some demonstrative aspects, the post processing capacity may be reduced while avoiding degradation of tracking operations, e.g., as it these operations may be important for interference mitigation.

In some demonstrative aspects, reducing the post processing capacity may free resources which may be utilized for performing one or more additional processing tasks using freed processing resources, e.g., as described below.

In some demonstrative aspects, reducing the post processing capacity may free resources which may be utilized for performing Al based algorithms, e.g., for interference detection and/or analysis.

In some demonstrative aspects, reducing the post processing capacity may free resources which may be utilized for performing an additional and/or more complex super resolution processing.

In some demonstrative aspects, reducing the post processing capacity may free resources which may be utilized for performing Doppler ambiguity, or selecting RD bin candidates for AoA processing, and/or for any other usage.

In some demonstrative aspects, processor 1040 may be configured to determine the radar processing scheme including a multi-snapshot processing scheme to configure a count of radar snapshots to process the radar data corresponding to the radar signals communicated by the RF frontend 1030, e.g., as described below.

In some demonstrative aspects, processor 1040 may be configured to determine a radar scheme according to a trade-off between the PC dimension size and interference mitigation, e.g., using one or more of the following methods:

TABLE 1

| Method | Gain | Penalty | Comments |
|---|---|---|---|
| Tx BF | 10log(FoV rate) | Reduced FoV | For both El and Az it |
| | | coverage | is 20log |
| Reduced | 10log(BW rate) | Reduced Range | |
| BW | | resolution | |
| Longer | 10log(pulse width | Reduced Max | Higher ambiguity. Can |
| Pulse | rate) | Doppler | be a major issue in low |
| | | | SINR condition |
| Multi | 10log(no of | Range migrations | Applicable for low ego |
| snapshots | snapshots rate) | and artifacts | speed |
| Reduced | Empirical. Can be | Reduced time | If used for super res., |
| Frame | 30 dB | resolution | still covers a small part |
| Rate | | | of the RD bins |
| Reduced | 40log(Range rate) | Detection range | An issue in high ego |
| Max | | | speed |
| Range | | | |
| Reduced | TBD | Tracking or | May be good together |
| PP | | higher load | with longer pulses |
| | | on system | |
| | | controller | |

In some demonstrative aspects, processor 1040 may be configured to adjust the PC dimension size, for example, based on a comparison between the value of the interference-based parameter and a threshold value, e.g., as described below.

In some demonstrative aspects, processor 1040 may be configured to monitor the value of the interference-based parameter, and to dynamically adjust the PC dimension size, for example, based on a detected change in the value of the interference-based parameter, e.g., as described below.

In some demonstrative aspects, processor 1040 may be configured to negotiate the PC dimension size with system controller 1050.

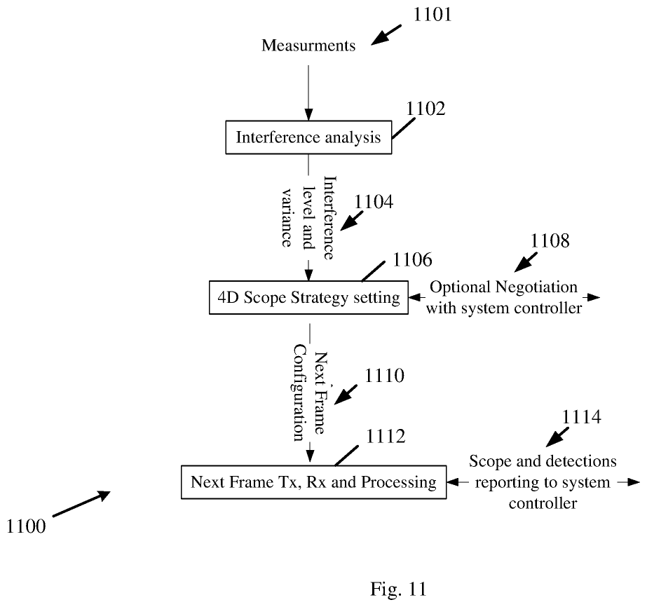

Reference is made to FIG. 11, which schematically illustrates a processing scheme 1100 to generate 4D PC radar information, in accordance with some demonstrative aspects.

In one example, processor 1040 (FIG. 10) may perform one or more operations and/or functionalities of processing scheme 1100, for example, to generate 4D PC radar information 1046 (FIG. 10).

In some demonstrative aspects, as shown in FIG. 11, processing scheme may be implemented to process a plurality of radar measurements 1101. For example, radar measurements 1101 may be obtained based on radar signals communicated by a radar device, e.g., RF frontend 1030 (FIG. 10).

In some demonstrative aspects, as indicated by arrow 1104, processing scheme 1100 may include determining a value of an interference-based parameter corresponding to an interference level, for example, based on analysis of the radar measurements 1101. For example, the value may indicate the interference level, a variance of the interference level, and/or any other parameter relating to the interference level. In one example, the variance of the interference level may include a variance over radio resources, e.g., frequency, time, code, polarization, or the like; and/or a spatial variance, e.g., in an azimuth dimension and/or an elevation dimension.

In one example, as indicated at block 1102, identifying the value of the interference-based parameter may be performed by an interference analysis process.

In some demonstrative aspects, the interference analysis process may be based on in-band measurements and/or out-of-band measurements, for example, to determine the level of interference.

In some demonstrative aspects, the in-band measurements may include measurements that may be performed as an integral part of a radar frame processing, e.g., by comparing noise floor levels between frames and/or on different parts of a 4D voxel grid.

In some demonstrative aspects, the out-of-band measurements may be based on a dedicated set of processing frames for the purpose of interference level analysis.

For example, the out-of-band measurements may be based on radar signals communicated between radar frames.

In some demonstrative aspects, the interference analysis process may implement a forgetting factor, for example, to provide a higher priority to recent measurements.

In some demonstrative aspects, the interference analysis process may include analyzing a variance of the interference between different radio resources.

In some demonstrative aspects, the interference analysis process may provide an estimation of the interference level, for example, based on a full processing chain, e.g., including Range, Doppler, and AoA estimation.

In some demonstrative aspects, the interference analysis process may provide an estimation of the interference level, for example, based on a full processing chain of mitigation modules, for example, including Range, Doppler, AoA estimation, adaptive null steering, adaptive filtering, and/or adaptive cancellation, e.g., by subtracting the interference.

In some demonstrative aspects, the interference level may be provided in terms of an SINR increase, for example, in dB or any other units, e.g., compared to a no-interference case.

In other aspects, the interference level may be determined based on any other parameter.

In some demonstrative aspects, the interference level may be associated with a sub-space of the 4D PC grid and may vary with radio resources. For example, the interference level may relate to a 76-77 GHz band, e.g., for radars operating in the 76-77 GHz band, while the allowed radar band may be wider, e.g., 76-81 GHz.

In some demonstrative aspects, the interference analysis process may be performed for some specific radio resource settings, e.g., in windows of a multi dimension radio resource size.

In some demonstrative aspects, the interference analysis process may be configured to compute variance of interferences, and tag radio resources.

In one example, the interference analysis process may be configured to tag a radio resource, as “Highly interfered”, “Typical”, or “Clean”, or using any other tagging scheme, e.g., based on the interference level and/or the variance corresponding to the radio resource.

In another example, the interference analysis process may be configured to provide a numeric score to a radio resource, for example, based on the interference level and/or the variance of the interference level corresponding to the radio resource.

In some demonstrative aspects, the interference analysis process may provide interference statistics including, for example, “collision probability” and/or “power” characteristics.

In one example, a radar tracker, or one or more higher layers, may recover from a harmful impact of interference, for example, even if the interference is very powerful, e.g., assuming the quality of each radar frame is estimated, for example, when the collision rate is low. For example, a remote or low power interferer may cause small SINR degradation. For example, processing scheme 1100 may be based on, and/or may be configured to consider, only interference statistics above a certain level of collision probability, e.g., around 10%, and/or a power level above a certain power level, e.g., a power level that creates more than 2 dB SINR degradation. For example, the level of collision probability and/or the power level may be set, for example, based on radar performance, tracker performance, higher-layer performance, e.g., based on input from system controller 1050 (FIG. 10), a perception policy of a radar system, e.g., radar system 901 (FIG. 9), and/or any other parameter.

In some demonstrative aspects, as indicated at box 1106, processing scheme 1100 may include determining one or more PC dimension sizes, e.g., according to a strategy setting to reduce the 4D PC scope. For example, the strategy setting may be determined based on the interference level. In one example, processor 1040 (FIG. 10) may be configured to determine the strategy setting according to a trade-off between a level of interference mitigation and the one or more PC dimension sizes, e.g., according to Table 1.

In some demonstrative aspects, the one or more PC dimension sizes may be determined according to a radar scheme and/or a strategy, which may be determined, e.g., according to a trade-off method, for example, based on a mission, the interference level, and/or the variance across radio resources. For example, the radar scheme may correspond to a 4D PC dimension size setting, e.g., as described above.

In some demonstrative aspects, as indicated by arrow 1108, determining the PC dimension size may include an optional negotiation of the PC dimension size with a system controller, e.g., system controller 1050 (FIG. 10).

In one example, the optional negotiation with the system controller 1050 may be with respect to a strategy setting to reduce the 4D PC scope.

In some demonstrative aspects, as indicated by arrow 1110, processing scheme 1100 may include configuring a next radar frame, e.g., according to the radar scheme and/or the strategy setting.

In some demonstrative aspects, the radar scheme may configure one or more Tx parameters, e.g., according to the strategy setting.

In some demonstrative aspects, the radar scheme may configure one or more Rx parameters, e.g., according to the strategy setting.

In some demonstrative aspects, as indicated at box 1112, processing scheme 1100 may include radar frame processing of the next frame.

In one example, the radar frame processing of the next frame may include Tx processing and/or Rx processing, for example, according to the radar scheme. For example, processor 1040 (FIG. 10) may control RF frontend 1030 (FIG. 10) to communicate radar signals of a next frame based on a radar communication scheme corresponding to the strategy setting.

In some demonstrative aspects, as indicated by arrow 1114, processing scheme 1100 may include reporting, for example, to a system controller, e.g., system controller 1050 (FIG. 10), the reduced 4D PC scope, and/or detections of targets based on the reduced 4D PC scope, e.g., with or without post processing.

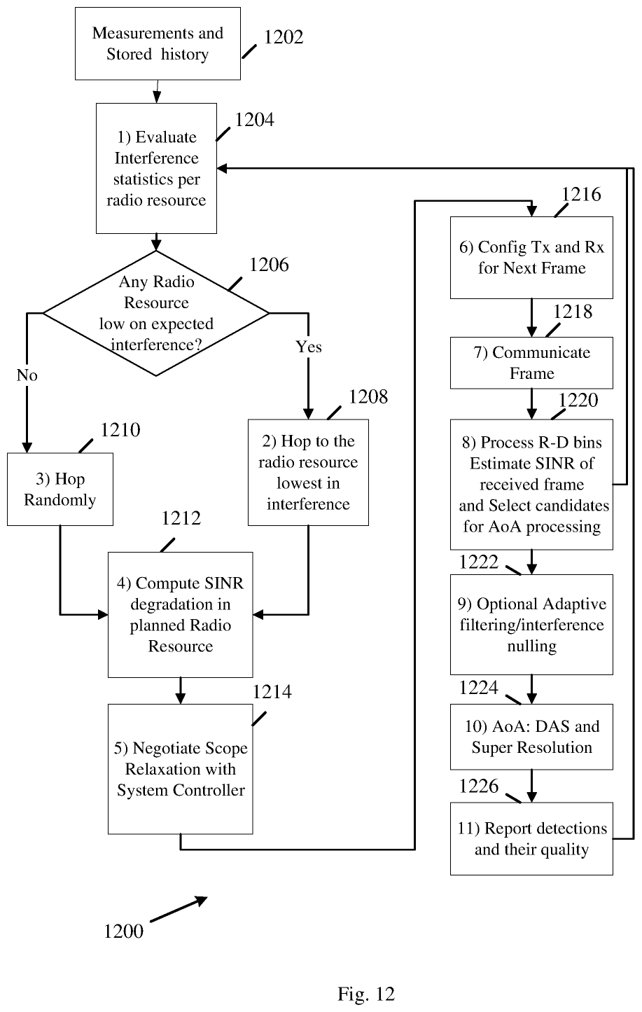

Reference is made to FIG. 12, which schematically illustrates a radar processing scheme 1200 to balance between an interference level, e.g., in terms of SINR, and a reduced 4D PC, in accordance with some demonstrative aspects.

In one example, processor 1040 (FIG. 10) may perform one or more operations and/or functionalities of radar processing scheme 1200, for example, to mitigate interference in an environment of radar device 910 (FIG. 9).

In some demonstrative aspects, as indicated at block 1202, one or more radar measurement and/or stored history of measurements 1202 may be received as an input, e.g., by processor 1040 (FIG. 10).

In some demonstrative aspects, as indicated at block 1204, radar processing scheme 1200 may include evaluating a value of an interference-based parameter corresponding to an estimated interference level in an environment of a radar device, e.g., radar device 910 (FIG. 9), for example, based on the one or more radar measurements and/or the stored history 1202.

In some demonstrative aspects, as indicated at block 1206, radar processing scheme 1200 may include determining whether or not there are radio resources, which are estimated be without interference or with low interference.

In some demonstrative aspects, as indicated at block 1208, radar processing scheme 1200 may include selecting a radio resource, which is estimated to be without interference or with low interference.

In one example, the radio resources may be ranked, for example, according to an interference level probability. For example, the interference level probability may be estimated, for example, according to a recent interference level of the interference and/or a variance of the interference.

In one example, an interference level corresponding to a radio resource may be determined, for example, based on an average interference level.

For example, processor 1040 (FIG. 10) may compute an average interference level and/or the variance in the interference level, e.g., in a Gaussian case, for the last K time units. For example, assuming a Gaussian or a Poisson point process, denoted θ, with an intensity distribution, denoted λ, e.g., is equal to λ=1/D, wherein D denotes existence of a car every D meter. For example, D may be estimated based on interference measurements, e.g., based on a number and/or a level of interferers, and/or may be received, e.g., from a system controller, e.g., system controller 1050 (FIG. 10).

In one example, a level of 90% percentile of a Cumulative Distribution Function (CDF) may be defined, for example, to compute the average interference level and/or the variance in the Gaussian case.

In another example, any other percentile, distributions, and/or interference estimation methods may be applied.

In some demonstrative aspects, as indicated at block 1210, radar processing scheme 1200 may include randomly selecting a radio resource, for example, if there are no identified radio resources, which are estimated to be without interference or with low interference.

In some demonstrative aspects, as indicated at block 1212, radar processing scheme 1200 may include computing an SNIR degradation for the selected radio resource.

In some demonstrative aspects, as indicated at block 1214, radar processing scheme 1200 may include negotiating a reduced 4D PC scope, for example, with a system controller, e.g., system controller 1050 (FIG. 10). For example, the reduced 4D PC scope may be determined with respect to the selected radio resource, e.g., in accordance with the SNIR degradation for the selected radio resource.

In some demonstrative aspects, the reduced PC scope may be based on a reduced PC dimension size.

In some demonstrative aspects, selection of a reduced PC dimension size may be based, for example, on an ego speed scenario corresponding to a speed of the radar device 910 (FIG. 9), e.g., as described below.

In some demonstrative aspects, for example, at a low speed ego scenario, the reduced PC dimension size may be determined according to a first ordered priority including the multi-snapshot processing scheme, the Tx pulse duration of the radar Tx signals, a post-processing reduction, a reduced frame rate, a reduced max range, a reduced BW, a reduced El FoV, and/or a reduced Az FoV.

In other aspects, any other priority may be applied for determining the reduced PC dimension size at the low speed scenario. [00395] some demonstrative aspects, at a medium ego speed scenario, the reduced PC dimension size may be determined according to a second ordered priority including a Reduced BW, a Reduced El FoV, the multi-snapshot processing scheme, the post-processing reduction, the reduced frame rate, the reduced max range, and/or the reduced Az FoV.

In other aspects, any other priority may be applied for determining the reduced PC dimension size at the medium speed scenario.

In some demonstrative aspects, at a high ego speed scenario, the reduced PC dimension size may be determined according to a third ordered priority including the reduced BW, the reduced El FoV, the reduced Az FoV, the reduced frame rate, and/or the reduced max range.

In other aspects, any other priority may be applied for determining the reduced PC dimension size at the high speed scenario.

In some demonstrative aspects, the negotiation with the system controller, e.g., system controller 1050 (FIG. 10), may include one or more operations to determine the reduced 4D PC scope, e.g., as described below.

In some demonstrative aspects, the negotiation with the system controller may include, for example, setting up a degradation threshold for the SINR degradation, e.g., as described below.

In some demonstrative aspects, the system controller, e.g., system controller 1050 (FIG. 10), may set up the degradation threshold.

In some demonstrative aspects, the degradation threshold may be static or dynamic.

In some demonstrative aspects, the degradation threshold may include an SINR degradation, e.g., in dB, or a linear SINR degradation.

In some demonstrative aspects, the degradation threshold may include a requirement of a reliable detection of an object having a minimal radar cross section (RCS), at a maximal range under interference, e.g., MIN_RCS at MAX_under_Interference_Range.

In some demonstrative aspects, the requirement of the reliable detection may be based on a radar mode of operation, e.g., SRR, MRR, LRR, or the like, and/or a Radar Unit type of the radar device.

In some demonstrative aspects, a radar device, e.g., radar device 910 (FIG. 9), may be configured to transform the requirement of the reliable detection to the SINR degradation, e.g., in dB or a linear SINR degradation.

In some demonstrative aspects, the negotiation with the system controller may assist in bringing the degradation due to the interference to a level, e.g., which may be better than or equal to the degradation threshold set by the system controller.

In some demonstrative aspects, a radar scheme may be selected from a plurality of predefined radar schemes, e.g., as according to a “fix allocation scheme”.

In one example, a radar device, e.g., radar device 910 (FIG. 9), and/or a system controller, e.g., system controller 1050 (FIG. 10), may be configured to store the plurality of predefined radar schemes, e.g., in the form of a table, or any other form.

In some demonstrative aspects, a radar scheme may be associated with a 4D cloud scope reduction and an SINR gain. For example, in case of RCS and range threshold, the transformation to SINR degradation may be based on a radar equation, and particular implementation inefficiencies.

In some demonstrative aspects, the selected radar scheme may be selected from the plurality of predefined radar schemes, for example, based on a current scene and/or a required SINR gain.

In some demonstrative aspects, an implementation based on determining the selected radar scheme from the plurality of predefined radar schemes may be advantageous, for example, for an efficient validation process and/or for AI training on a pre-defined radar output 4D point cloud scope and/or a predefined frame rate.

In some demonstrative aspects, the plurality of predefined radar schemes may include one or more of the following radar schemes:

TABLE 2

| | | | Gain | |
|---|---|---|---|---|
| ID | Scope degradation | Methods | example | |
| 1. | Reduced MRR FoV to half, e.g., | In multi-mode RU, can | 3 | dB |
| | from 120 deg to 60 deg | replace the MRR with | | |
| | | steered LRR, to have two | | |
| | | LRRs, e.g., 30 deg each, | | |
| | | covering 2*30 = 60deg | | |
| 2. | Reduced El FoV, e.g., to ¼ | Tx BF | 6 | dB |
| 3. | 1 + 2 | 1 + 2 | 9 | dB |
| 4. | Reduced BW to half | Chirp of less steep slope | 3 | dB |
| 5. | 3 + 4 | 3 + 4 | 12 | dB |
| 6. | Reduced max range, e.g., to ⅔ | Rx based method | 7 | dB |
| 7. | Use Super Resolution for | Super resolution | 6 | dB |
| | remote/week detections | | | |
| 8. | 1 to 7 | 1 to 7 | 25 | dB |
| 9. | 5 + partial 7 | 5 + partial 7 | 15 | dB |
| 10. | Reduced Az FoV scope, e.g., | Use Super resolution to | 6 | dB |
| | to ¼ | all El in the center FoV | | |
| 11. | Reduced Az FoV scope, e.g., | Tx BF | 6 | dB |
| | to ¼ | | | |
| 12. | 10 + 11 | 9 + 10 | 12 | dB |

In other aspects, the plurality of predefined radar schemes may include any other additional and/or alternative radar schemes.

In one example, according to Table 2, a radar scheme with the ID 4 may be configured to reduce the frequency BW to half of a supported frequency BW, for example, by configuring a chirp having a less steep slope, for example, to provide an estimated gain of 3 dB.

In one example, according to Table 2, a radar scheme with the ID 11, may be configured to reduce an Az FoV scope, e.g., to a fourth of a supported Az FoV scope, for example, by performing Tx BF, for example, to provide an estimated gain of 6 dB.

In some demonstrative aspects, the radar scheme may be determined dynamically for example, by the radar device, e.g., radar device 910 (FIG. 9), and/or the system controller, e.g., system controller 1050 (FIG. 10), e.g., according to a “dynamic allocation scheme”.

In some demonstrative aspects, a dynamic selection of the radar scheme may allow a finer granularity, and/or may be used to tradeoff between the reduced 4D PC scope and performance.

In some demonstrative aspects, the system controller, e.g., system controller 1050 (FIG. 10), may be configured to provide a list of scope degradations, e.g., including a plurality of reduced 4D PC scopes.

In some demonstrative aspects, the radar device, e.g., radar device 910 (FIG. 9), may utilize the plurality of reduced 4D PC scopes, for example, to improve SINR, e.g., until the SINR degradation threshold is achieved, and/or until the radar device exercised all of the plurality of reduced 4D PC scopes.

In some demonstrative aspects, the radar device, e.g., radar device 910 (FIG. 9), may utilize the plurality of reduced 4D PC scopes, for example, to assist and/or to complement one or more canceling and/or nulling methods.

In some demonstrative aspects, as indicated at block 1216, radar processing scheme 1200 may include configuring a Tx settings and/or an Rx settings for a next frame, for example, according to the radar strategy selected for the reduced PC dimension size.

In some demonstrative aspects, as indicated at block 1218, radar processing scheme 1200 may include communicating the next frame, for example, according to the Tx settings and/or the Rx settings corresponding to the selected radar scheme.

In some demonstrative aspects, as indicated at block 1220, radar processing scheme 1200 may include processing Range-Doppler (RD) bins, and selecting one or more candidates of the RD bins for AoA processing.

In some demonstrative aspects, as indicated at block 1222, radar processing scheme 1200 may optionally include applying adaptive filtering and/or interference nulling, for example, to mitigate interference.

In some demonstrative aspects, as indicated at block 1224, radar processing scheme 1200 may include using one or more super resolution algorithms, e.g., Minimum Variance Distortionless Response (MVDR) based algorithms, MUltiple SIgnal Classification (MUSIC) algorithms, or the like. For example, the one or more super resolution algorithms may be implemented, for example, for RD bins that have an increased level, e.g., a ridge, of interference, which may mask small targets. For example, the super resolution algorithms may be implemented to leverage processing gain.

In some demonstrative aspects, as indicated at block 1222, radar processing scheme 1200 may include reporting an interference level, and/or credibility per each detection, e.g., to system controller 1050 (FIG. 10). For example, the credibility per detection may be reported. In one example, the credibility per detection may be utilized, for example, in case there are not enough compute resources to implement super resolution in all required RD bins, and/or when the AoA processing was not good enough, e.g., when the interference level is very strong.

In some demonstrative aspects, processor 1040 (FIG. 10) may be configured to selectively apply one or more operations of radar processing scheme 1200 with respect to one or more scenarios, e.g., as described below.

In some demonstrative aspects, processor 1040 (FIG. 10) may apply one or more operations of radar processing scheme 1200 in a highway driving scenario, e.g., of vehicle 900 (FIG. 9).

In some demonstrative aspects, the highway driving scenario may include a quasi-static part, e.g., cars traveling along a same direction as the vehicle; and/or a dynamic part, e.g., a more dynamic and/or an unexpected part, for example, cars traveling on an opposite direction to the vehicle 900 (FIG. 9).

In some demonstrative aspects, according to blocks 1202 and/or 1204, processor 1040 (FIG. 10) may build a solid perception of interference over time, which may be sourced by cars traveling along the same direction of vehicle 900 (FIG. 9).

In some demonstrative aspects, processor 1040 (FIG. 10) may identify low-interference radio resources, e.g., frequency resources, time resources, polarization resources, waveform patterns, and/or the like, for example, based on the solid perception.

In some demonstrative aspects, processor 1040 (FIG. 10) may configure Tx parameters, for example, based on the low-interference radio resources, and/or based on negotiation with system controller 1050 (FIG. 10), e.g., as indicated by blocks 1214, and/or 1216.

In some demonstrative aspects, radar processing scheme 1200 may be implemented to reduce interference, for example, to radar units of other cars. For example, reducing the PC dimension, for example, by hopping to different frequency ranges, changing transmit time, changing between unified frame and/or a burst mode, changing waveform, e.g., between chirp to Phase modulation, changing waveform parameters, e.g., chirp slope, changing the BW, changing a delay or a frequency offset within the array, polarization orientation, and/or the like, may assist in reducing interference caused by transmissions from the vehicle 900 (FIG. 9) to the other cars

In some demonstrative aspects, an unexpected interference may appear from time to time, for example, due to the traffic in the opposite direction.

In some demonstrative aspects, processor 1040 (FIG. 10) may detect the unexpected interference, and, accordingly may balance one or more Rx and/or Tx settings, e.g., as indicated by block 1216.

In some demonstrative aspects, processor 1040 (FIG. 10) may balance the one or more Tx and/or Rx settings, for example, by limiting the FoV, the maximal range, and/or by allocating a higher percentage of RD bins to be processed by super resolution algorithms.

In one example, it may be assumed that the interference resulting from cars along the traffic in the highway driving scenario may contribute a 14 dB raise in the noise floor. According to this example, implementing radar processing scheme 1200 may achieve a 14 dB gain.

In some demonstrative aspects, according to a first balancing scheme, processor 1040 (FIG. 10) may achieve the 14 dB gain, for example, by moving to the LRR mode, e.g., with a reduced FoV. In one example, the reduced FoV may include ¼ of the FoV, or any other part of the FoV, in Az and/or El. This reduced FoV may contribute, for example, a 6 dB gain in each dimension, resulting with an overall gain of a 12 db.

In some demonstrative aspects, processor 1040 (FIG. 10) may accommodate the remaining 2 dB, for example, by using super resolution algorithms to process a solid angle that spans the lanes of cars traveling to the same direction and the road vicinity.

In some demonstrative aspects, according to a second balancing scheme, processor 1040 (FIG. 10) may achieve the 14 dB gain, for example, by moving to the MRR mode with a reduced BW, e.g., by a factor of 4, using a reduced FoV, e.g., by Tx BF in El, which may contribute 3 dB or more, reducing the frame rate, increasing the frame size, e.g., using a longer frame by 1.5, and/or reducing a maximal range, e.g., using 80% of the maximal range. Additionally, more super resolution processing may be allowed, for example, to provide the required gain.

In one example, the balancing gain of the second balancing scheme may be determined, e.g., as follows:

10*log 10(4)+3+10*log 10(1.5)+40*log 10(1/0.8)=14.6 dB+optional usage of super resolution algorithms (6)

In some demonstrative aspects, processor 1040 (FIG. 10) may reduce the PC dimension size, for example, to increase an availability of processing resources for super resolution algorithms.

In one example, it may be assumed that processor 1040 (FIG. 10) can process k % of RD bin with super resolution. According to this example, processor 1040 (FIG. 10) may increase the value of the parameter k, for example, by applying a Tx BF to reduce the FoV, e.g., which may result with less hypothesis to calculate, for example, by a factor of two for the FoV and overall hypothesis count.

In one example, processor 1040 (FIG. 10) may increase the value of the parameter k, for example, by reducing the frame rate by half, or any other factor. For example, this reduction in the frame rate may provide another factor, e.g., of 2.

In one example, processor 1040 (FIG. 10) may reduce the max range, e.g., by 0.8 or any other factor, which may provide an additional gain, e.g., of 1/0.8.

In one example, some or all of the operations described above may be implemented to provide a possibility of processing more RD bins with super-resolution to process their AoA. In one example, an overall hypothesis number may decrease, e.g., by 2*2/0.8=5 times, e.g., compared to an original PC scope. This reduction may be utilized to free up processing power, which may be used for super resolution AoA methods.

In some demonstrative aspects, processor 1040 (FIG. 10) may detect an un-expected high interference.

In some demonstrative aspects, processor 1040 (FIG. 10) may perform one or more operations of radar processing scheme 1200, for example, to mitigate the un-expected high interference.

In some demonstrative aspects, processor 1040 (FIG. 10) may balance the un-expected high interference, for example, by reducing a reported maximal range grid, and/or a reported AoA maximal range, for example, to allow more super-resolution processing.

In some demonstrative aspects, processor 1040 (FIG. 10) may balance the un-expected high interference, for example, by applying a longer processing time per frame, e.g., using a reduced FPS.

In some demonstrative aspects, processor 1040 (FIG. 10) may null the un-expected high interference, for example, using an adaptive filtering, e.g., to null the strongest set of interference sources.

In some demonstrative aspects, processor 1040 (FIG. 10) may balance the un-expected high interference, for example, by selecting a predefined radar scheme, for example, radar scheme #9 of Table 2.

In some demonstrative aspects, processor 1040 (FIG. 10) may balance the un-expected high interference, for example, by performing dynamic allocation of a radar scheme, e.g., as described above.

In one example, a first dynamic allocation may include reducing the El FoV to a fourth of the supported El FoV, reducing the Az FoV to half of the supported Az FoV, and/or reducing the frequency BW to half of the frequency BW. According to this example, the dynamic balancing scheme may achieve a 12 dB increase in SINR. For example, an additional 2 dB may be left unmitigated, or the additional 2 dB may be mitigated by applying super resolution on remote/weak detections.

In another example, a second dynamic allocation may include reducing the El FoV to a fourth of the supported El FoV, reducing the Az FoV to half of the supported Az FoV, and reducing the frequency BW to half of the frequency BW. According to this example, the second dynamic balancing scheme may achieve a 12 dB increase to SINR. For example, an additional 2 dB may be achieved by reducing a maximal range, for example, to 0.89 of the maximal range, e.g., 10\hat{ }(−2/40)=0.89.

In some demonstrative aspects, processor 1040 (FIG. 10) may apply radar processing scheme 1200 for a traffic jam scenario in an urban environment, for example, using the same methods and/or operations described above with respect to the highway driving scenario, for example, while applying lower dynamics.

In some demonstrative aspects, processor 1040 (FIG. 10) may apply radar processing scheme 1200 in a sporadic traffic scenario, e.g., as described below.

In one example, in the sporadic traffic scenario, the traffic may not be dense, but may have a highly dynamic profile. According to this example, prediction performance may be expected to be low.

In some demonstrative aspects, processor 1040 (FIG. 10) may randomly hop over an entire radio resources span, e.g., as a most suitable Tx strategy.

In some demonstrative aspects, when a frame is received with interference, a tracker may manage to filter the erroneous detections, for example if the frame is an isolated frame between relatively clean frames. For example, in other cases, processor 1040 (FIG. 10) may mitigate the interference in the sporadic traffic scenario, for example, using the same methods and/or operations described above with respect to the highway driving scenario.

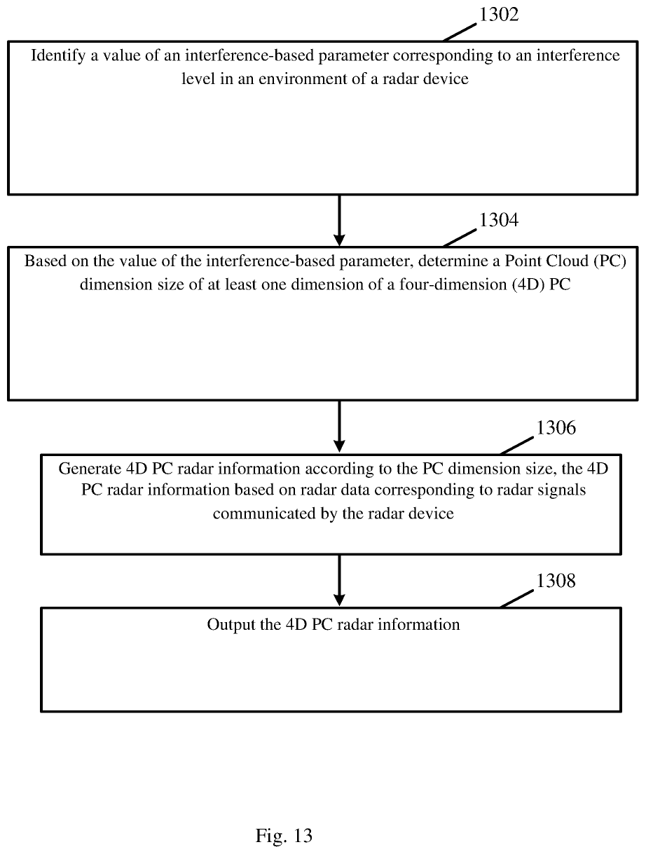

Reference is made to FIG. 13, which schematically illustrates a method of generating 4D PC radar information, in accordance with some demonstrative aspects. For example, one or more of the operations of the method of FIG. 13 may be performed by a radar system, e.g., radar system 900 (FIG. 9), a radar device, e.g., radar device 101 (FIG. 1), radar device 800 (FIG. 8), and/or radar device 910 (FIG. 9); a processor, e.g., processor 1040 (FIG. 10), radar processor 834 (FIG. 8), and/or baseband processor 930 (FIG. 9); and/or a controller, e.g., controller 1050 (FIG. 10), and/or controller 950 (FIG. 9).

As indicated at block 1302, the method may include identifying a value of an interference-based parameter corresponding to an interference level in an environment of a radar device. For example, processor 1040 (FIG. 10) may be configured to identify the value of the interference-based parameter corresponding to the interference level in an environment of the radar device 910 (FIG. 9), e.g., as described above.

As indicated at block 1304, the method may include determining, based on the value of the interference-based parameter, a PC dimension size of at least one dimension of a 4D PC. For example, processor 1040 (FIG. 10) may be configured to determine the PC dimension size of the at least one dimension of the 4D PC, for example, based on the value of the interference-based parameter, e.g., as described above.

As indicated at block 1306, the method may include generating 4D PC radar information according to the PC dimension size, the 4D PC radar information based on radar data corresponding to radar signals communicated by the radar device. For example, processor 1040 (FIG. 10) may be configured to generate the 4D PC radar information 1046 (FIG. 10) according to the PC dimension size, wherein the 4D PC radar information 1046 (FIG. 10) may be based on radar data corresponding to radar signals communicated by the radar device 910 (FIG. 9), e.g., as described above.

As indicated at block 1308, the method may include outputting the 4D PC radar information. For example, processor 1040 (FIG. 10) may be configured to cause output 1042 (FIG. 10) to output the 4D PC radar information 1046 (FIG. 10), e.g., as described above.

Referring back to FIG. 9, in some demonstrative aspects, there may be a need to provide a technical solution to mitigate radio interference between radar devices, for example, radio interference at radar devices of vehicle 900, which may be caused by cross-talk and radar communications from other radar devices, e.g., of other vehicles, and/or one or more other radar communication sources, e.g., as described below.

In some demonstrative aspects, a number of vehicles equipped with radar devices may be expected to grow, for example, as importance of a radar sensor as an autonomous driving major sensor increases.

In some demonstrative aspects, radio interference between radar devices may be expected to grow as well, e.g., as a result of the increase in the number of autonomous vehicles utilizing radar devices.

In some demonstrative aspects, radio interference between radar devices may affect the performance of the radar devices, for example, in terms of a degraded radar effective range, a reduced probability of detections, an increase in a number of false alarm detections, and/or any other effects which may degrade the radar performance.

In some demonstrative aspects, for example, in some use cases, scenarios, and/or implementations, there may be one or more disadvantages, inefficiencies, and/or technical problems in implementing interference mitigation methods, which relay on BB processing at a data path to actively cancel interference in the BB processing data path.

In one example, interference mitigation methods, which relay on BB processing at a data path, may suffer performance degradation, and/or may be based on pre-assumptions, which may not always be suitable for an actual AV environment.

In some demonstrative aspects, for example, in some use cases, scenarios, and/or implementations, there may be one or more disadvantages, inefficiencies, and/or technical problems in implementing in the BB processing data path interference mitigation methods, which are based on filtering and/or spectral subtraction. In one example, these mitigation methods may require a reference signal, and/or may not be suitable for non-stationary signals.

In some demonstrative aspects, for example, in some use cases, scenarios, and/or implementations, there may be one or more disadvantages, inefficiencies, and/or technical problems in implementing in the BB processing data path interference mitigation methods, which are based on Wiener filtering. In one example, these mitigation methods may require a reference signal, and/or may not be suitable for non-stationary signals.

In some demonstrative aspects, for example, in some use cases, scenarios, and/or implementations, there may be one or more disadvantages, inefficiencies, and/or technical problems in implementing in the BB processing data path interference mitigation methods, which are based on adaptive Least Mean Squares (LMS) filtering with a reference signal via a listening window. In one example, these mitigation methods may require a reference signal, and/or may not be suitable for non-stationary signals.

In some demonstrative aspects, for example, in some use cases, scenarios, and/or implementations, there may be one or more disadvantages, inefficiencies, and/or technical problems in implementing in the BB processing data path interference mitigation methods, which are based on adaptive noise cancellation based on interference estimation for an analog de-chirp negative BW. In one example, these mitigation methods may only be suitable for systems utilizing analog de-chirp methods, and may not be suitable for digital SW defined Radars (SDR), e.g., which may use a wide band Analog to Digital Converter (ADC) to capture raw data before a de-chirp. For example, some digital SW defined radars may use an entire complex BW for data processing, e.g., in opposed to post analog de-chirp ADC samplers, which may require capturing only a real signal.

In some demonstrative aspects, for example, in some use cases, scenarios, and/or implementations, there may be one or more disadvantages, inefficiencies, and/or technical problems in implementing in the BB processing data path interference mitigation methods, which are based on a Space-Time Adaptive Filter (STAP). In one example, these mitigation methods may require usage of an interference covariance matrix from adjacent range cells, which may result in multiple snapshots.

In some demonstrative aspects, for example, in some use cases, scenarios, and/or implementations, there may be one or more disadvantages, inefficiencies, and/or technical problems in implementing in the BB processing data path interference mitigation methods, which are based on chirp interference reconstruction, for example, from an ADC signal. In one example, these mitigation methods may be suitable for a single chirp, and may not be scalable for multiple chirps.

In some demonstrative aspects, for example, in some use cases, scenarios, and/or implementations, there may be one or more disadvantages, inefficiencies, and/or technical problems in implementing in the BB processing data path interference mitigation methods, which are based on an Independent Component Analysis (ICA) based interference reconstruction, e.g., based on a target signal distortion. In one example, these mitigation methods may require manual identification of an interference signal from unmixed signals.

In some demonstrative aspects, for example, in some use cases, scenarios, and/or implementations, there may be one or more disadvantages, inefficiencies, and/or technical problems in implementing in the BB processing data path interference mitigation methods, which are based on transmit waveform slope diversity. In one example, these mitigation methods may increase a noise floor and/or may result in a tradeoff in frame time, which may require an additional Rx mitigation algorithm.

In some demonstrative aspects, for example, in some use cases, scenarios, and/or implementations, there may be one or more disadvantages, inefficiencies, and/or technical problems in implementing in the BB processing data path interference mitigation methods, which are based on transmit waveform-coded Piecewise Linear Frequency Modulation (PLFM), e.g., using a phase coded FMCW. In one example, these mitigation methods may degrade performance, e.g., a high dynamic range Key Performance Indicators (KPIs) may not be met.

In some demonstrative aspects, a radar device, e.g., radar device 910, may be configured to mitigate interference in an environment of the radar device 910, e.g., an environment of vehicle 900, for example, according to a radar processing scheme, for example, a radar-interference shaping scheme, e.g., as described below.

In some demonstrative aspects, the radar processing scheme may be configured to shape interference noise of an interference signal, for example, instead of canceling the interference signal in the data path, e.g., as described below.

In some demonstrative aspects, the radar processing scheme may be configured to filter the interference signal in an upper tracking layer, for example, based on the shaping of the interference signal, e.g., as described below.

In some demonstrative aspects, the radar processing scheme may be configured to mitigate the interference, for example, by configuring one or more radar Tx parameters of the radar signals transmitted by the device to match one or more corresponding parameters of the interference signal, e.g., as described below.

In some demonstrative aspects, an interference mitigation mechanism based on matching the one or more radar Tx parameters to the one or more corresponding parameters of the interference signal may provide a technical solution to focus some, most, or even all, the interference into one or more particular bins, e.g., a single bin, in the 4D cube.

In some demonstrative aspects, the focusing of the interference into one or more particular bins, e.g., a single bin, may support a technical solution maintain at a reduced, e.g., minimal, level a noise floor due to the interference, e.g., as described below.

In some demonstrative aspects, the focusing of the interference into one or more particular bins, e.g., a single bin, may support a technical solution in which the interference may appear as a non-valid detection, e.g., a ghost target, in the in the 4D cube, e.g., as described below. For example, in many use cases, filtering the non-valid detection, e.g., the ghost target, by an upper layer, e.g., a tracker, may be guaranteed, e.g., due to a nature of the environment of an AV radar device.

In some demonstrative aspects, a time shift, e.g., in the form of a jitter or any other time shift, may be added to a start of a Tx frame, for example, to result in a jitter in a location of the non-valid detection resulting from the interference, such that the non-valid detection resulting from the interference may be filtered by the tracker, e.g., as being a ghost target.

In some demonstrative aspects, the radar processing scheme may be configured to support a technical solution, which may avoid an increase in an entire 4D noise floor, e.g., in presence of the interference, while maintaining a dynamic range and/or KPIs of the radar device, e.g., as described below.

In some demonstrative aspects, the radar processing scheme may be implemented to provide a technical solution to mitigate interference for radar devices using an FMCW modulation, and/or any other modulation scheme.

In some demonstrative aspects, the radar processing scheme may be implemented to provide a technical solution to mitigate interference for digital SW defined Radar (SDR), and/or any other types of radar devices.

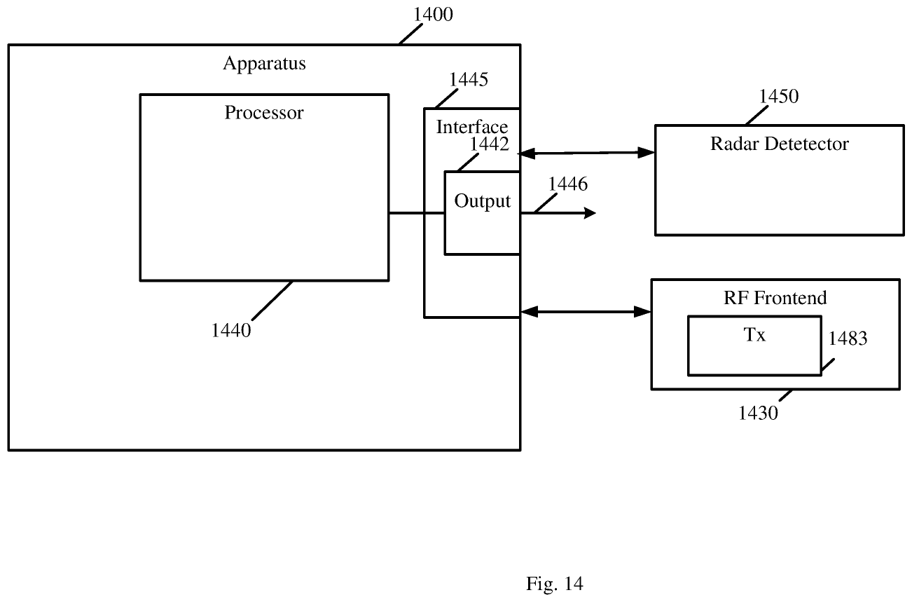

Reference is made to FIG. 14, which schematically illustrates a processor apparatus 1400, in accordance with some demonstrative aspects.

In some demonstrative aspects, apparatus 1400 may be configured to implement and/or to support a radar processing scheme, e.g., as described below.

In some demonstrative aspects, apparatus 1400 may be implemented, for example, as part of a radar device, e.g., a radar device 910 (FIG. 9).

In some demonstrative aspects, apparatus 1400 may be implemented, for example, as part of a controller, e.g., controller 950 (FIG. 9).

In some demonstrative aspects, apparatus 1400 may be implemented, for example, as part of a radar processor, e.g., radar processor 834 (FIG. 8), and/or BB processor 930 (FIG. 9).

In some demonstrative aspects, apparatus 1400 may include an interface 1445 configured to interconnect and/or interface between apparatus 1400 and one or more other devices, components and/or elements of a radar device, e.g., radar device 910 (FIG. 9), and/or a radar system, e.g., radar system 901 (FIG. 9).

In some demonstrative aspects, interface 1445 may interconnect and/or interface between apparatus 1400 and a radar detector 1450. For example, radar detector 1450 may include one or more elements of controller 950 (FIG. 9) and/or vehicle controller 108 (FIG. 1), and/or may perform one or more operations and/or functionalities of controller 950 (FIG. 9) and/or vehicle controller 108 (FIG. 1).

In some demonstrative aspects, interface 1445 may interconnect and/or interface between apparatus 1400 and one or more elements and/or components of a radar device, for example, one or more components elements of radar device 910 (FIG. 9), and/or one or more components or elements of radar device 800 (FIG. 8).

In some demonstrative aspects, interface 1445 may interconnect and/or interface between apparatus 1400 and at least one RF frontend 1430 of the radar device. For example, RF frontend 1430 may include one or more elements of radar front end 804 (FIG. 8) and/or RFICs 920 (FIG. 9), and/or may perform one or more operations and/or functionalities of radar front end 804 (FIG. 8) and/or RFICs 920 (FIG. 9).

In some demonstrative aspects, RF frontend 1430 may include a transmitter 1483 configured to transmit Tx radar signals. For example, transmitter 1483 may include one or more elements of transmitter 883 (FIG. 8), and/or may perform one or more operations and/or functionalities of transmitter 883 (FIG. 8).

In some demonstrative aspects, apparatus 1400 may include a processor 1440 configured to generate and/or process radar information for a radar device, for example, radar device 910 (FIG. 9), and/or a radar system, e.g., radar system 901 (FIG. 9), e.g., as described below. For example, radar processor 834 (FIG. 8) may include one or more elements of processor 1440, and/or may perform one or more operations and/or functionalities of processor 1440; BB processor 930 (FIG. 9) may include one or more elements of processor 1440, and/or may perform one or more operations and/or functionalities of processor 1440; and/or controller 950 (FIG. 9) may include one or more elements of processor 1440, and/or may perform one or more operations and/or functionalities of processor 1440.

In some demonstrative aspects, processor 1440 may include, or may be implemented, partially or entirely, by circuitry and/or logic, e.g., one or more processors including circuitry and/or logic, memory circuitry and/or logic. Additionally or alternatively, one or more functionalities of processor 1440 may be implemented by logic, which may be executed by a machine and/or one or more processors, e.g., as described below.

In some demonstrative aspects, processor 1440 may be configured to determine a setting of one or more Tx parameters, for example, to configure Tx radar signals to be transmitted by transmitter 1483, e.g., as described below.

In some demonstrative aspects, the one or more Tx parameters may include a slope of a Tx radar signal, a bandwidth of the Tx radar signal, and/or a time duration of the Tx radar signal, e.g., as described below.

In some demonstrative aspects, the one or more Tx parameters may include a modulation type of the Tx radar signal, a MIMO scheme to transmit the Tx signal, and/or a coding of the Tx radar signal, e.g., as described below.

In other aspects, one or more Tx parameters may include any other additional or alternative parameters to configure the Tx radar signals to be transmitted by transmitter 1483.

In some demonstrative aspects, processor 1440 may be configured to adjust the setting of the one or more Tx parameters from a first Tx parameter setting to a second Tx parameter setting, for example, based on an interference Tx parameter estimation corresponding to the one or more Tx parameters, e.g., as described below.

In some demonstrative aspects, the interference Tx parameter estimation may correspond to an interferer in an environment of the radar device including transmitter 1483, e.g., as described below.

In some demonstrative aspects, processor 1440 may be configured to determine the second Tx parameter setting, for example, such that a correlation between the second Tx parameter setting and the interferer Tx parameter estimation may be greater than a correlation between the first Tx parameter setting and the interferer Tx parameter estimation, e.g., as described below.

In some demonstrative aspects, processor 1440 may be configured to determine the second Tx parameter setting, for example, to have a correlation of at least 60% with the interference Tx parameter estimation, e.g., as described below.

In some demonstrative aspects, processor 1440 may be configured to determine the second Tx parameter setting, for example, to have a correlation of at least 70% with the interference Tx parameter estimation, e.g., as described below.

In some demonstrative aspects, processor 1440 may be configured to determine the second Tx parameter setting, for example, to have a correlation of at least 80% with the interference Tx parameter estimation, e.g., as described below.

In some demonstrative aspects, processor 1440 may be configured to determine the second Tx parameter setting, for example, to have a correlation of at least 90% with the interference Tx parameter estimation, e.g., as described below.

In other aspects, processor 1440 may be configured to determine the second Tx parameter setting, for example, to have any other level of correlation with the interference Tx parameter estimation.

In some demonstrative aspects, processor 1440 may be configured to generate Tx parameter information 1446 for the transmitter 1483, e.g., as described below.

In some demonstrative aspects, the Tx parameter information 1446 may be based on the setting of one or more Tx parameters, e.g., as described below.

In some demonstrative aspects, processor 1440 may include an output 1442 to provide Tx parameter information 1446, for example, to transmitter 1483, e.g., as described below.

In some demonstrative aspects, processor 1440 may be configured to communicate output 1442 directly to transmitter 1483, e.g., via interface 1445. In other aspects, processor 1440 may be configured to provide output 1442 to transmitter 1483 via any other element or component. For example, processor 1440 may be configured to provide output 1442 to a controller, e.g., controller 950 (FIG. 9), which may be configured to control transmitter 1483 based on the setting of one or more Tx parameters as indicated by output 1442.

In some demonstrative aspects, the interference Tx parameter estimation, which may be utilized by the processor 1440 to determine the second Tx parameter setting, may be based, for example, on radar signals communicated by the RF frontend 1430 based on the first Tx parameter setting, e.g., as described below.

In some demonstrative aspects, the interference Tx parameter estimation may be based on Rx radar signals received by the RF frontend 1430 based, for example, on first Tx radar signals transmitted by the transmitter 1483 according to the first Tx parameter setting, e.g., as described below.

In some demonstrative aspects, processor 1440 may be configured to determine the second Tx parameter setting to configure second Tx radar signals to be transmitted by the transmitter 1483, for example, subsequent to the first Tx signals, e.g., as described below.

In some demonstrative aspects, processor 1440 may be configured to determine the second Tx parameter setting, for example, such that a detection corresponding to the interferer in a radar detection result is detectable as a non-valid detection. For example, the radar detection result may be based on Tx radar signals transmitted by the transmitter 1483 according to the second Tx parameter setting, e.g., as described below.

In some demonstrative aspects, radar detector 1450 may be configured to determine the radar detection result, for example, based on the Tx radar signals transmitted by the transmitter 1483, e.g., as described below.

In some demonstrative aspects, radar detector 1450 may be configured to determine the radar detection result, for example, based on Rx radar signals, which may be received by the RF frontend 1430 based on the Tx radar signals transmitted by the transmitter 1483.

In some demonstrative aspects, radar detector 1450 may be configured to determine the radar detection result based on the Tx radar signals transmitted by the transmitter 1483 according to the second Tx parameter setting.

In some demonstrative aspects, processor 1440 may be configured to determine the second Tx parameter setting, for example, such that the radar detector 1450 may determine that a detection in the radar detection result corresponding to the interferer is a non-valid detection, e.g., as described below.

In some demonstrative aspects, processor 1440 may be configured to determine the second Tx parameter setting to provide a radar detection result having a noise floor, which is lower, for example, than a noise floor according to the first Tx parameter setting, e.g., as described below.

In some demonstrative aspects, the radar detection result may be based, for example, on the second Tx radar signals transmitted by the transmitter 1483, for example, according to the second Tx parameter setting, e.g., as described below.

In some demonstrative aspects, processor 1440 may be configured to determine the interference Tx parameter estimation based on the noise floor according to the first Tx parameter setting, e.g., as described below.

In some demonstrative aspects, processor 1440 may be configured to set the Tx parameter information 1446 to indicate a time shift to be introduced to a start time of a transmission of the Tx radar signals according to the second Tx parameter setting, e.g., as described below.

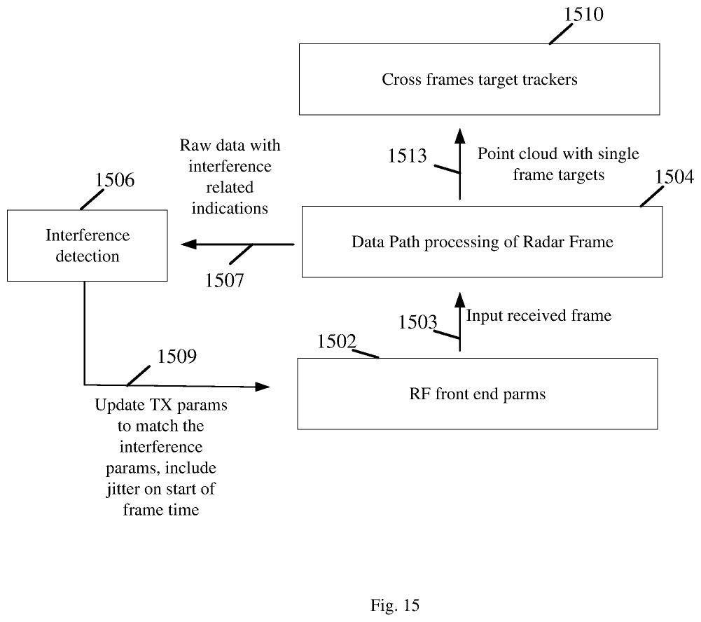

Reference is made to FIG. 15, which schematically illustrates a radar processing scheme 1500 to process radar communications, in accordance with some demonstrative aspects.

In one example, processor 1440 (FIG. 14) may perform one or more operations and/or functionalities of processing scheme 1500, for example, to generate Tx parameter information 1446 (FIG. 14) for transmitter 1483 (FIG. 14).

In some demonstrative aspects, an RF frontend 1502 may generate radar frame information 1503, e.g., based on radar Rx signals received by the RF frontend 1502.

In some demonstrative aspects, the radar Rx signals received by the RF frontend 1502 may be based on radar Tx signals transmitted by the RF frontend 1502 according to a Tx parameter setting of one or more Tx parameters.

For example, RF frontend 1430 (FIG. 14) may generate radar frame information 1503 based on radar Rx signals received by the RF frontend 1420 (FIG. 14). The radar Rx signals may be received by the RF frontend 1420 (FIG. 14), for example, based on radar signals transmitted by the RF frontend 1420 (FIG. 14) according to the Tx parameter setting of the one or more Tx parameters.

In some demonstrative aspects, the radar frame information 1503 may be processed, for example, by a radar data-path processing scheme 1504. For example, RF frontend 1430 (FIG. 14) may provide the radar frame 1503 to processor 1440 (FIG. 14), for example, for the radar data-path processing.

In some demonstrative aspects, the radar data-path processing 1504 may provide processed information 1507, which may include raw data including interference related indications, e.g., corresponding to the processed radar frame. For example, the radar data-path processing 1504 may include analysis of the radar frame to estimate one or more parameters corresponding to interference affecting the radar frame. The parameters corresponding to interference may be determined using any suitable interference detection mechanisms.

In some demonstrative aspects, the processed information 1507 may include an interference Tx parameter estimation corresponding to an interferer in an environment of a radar device implementing the processing scheme 1500.

In some demonstrative aspects, the radar processing scheme 1500 may include an interference detector 1506 to detect and attempt to mitigate interference based on the interference Tx parameter estimation.

In some demonstrative aspects, the interference detector 1506 may be configured to determine an updated Tx parameter settings 1509, for example, based on the interference Tx parameter estimation.

In some demonstrative aspects, the interference detector 1506 may be configured to determine an updated Tx parameter settings 1509, for example, such that a correlation between the updated Tx parameter setting 1509 and the interference Tx parameter estimation is greater than a correlation between the current Tx parameter setting and the interference Tx parameter estimation, e.g., as described above.

In some demonstrative aspects, the updated Tx parameter settings may be configured to correlate, or even match, between one or more parameters of a Tx radar signal to be communicated by the RF frontend 1502 and one or more respective parameters of the interference Tx parameter estimation.

In one example, the interference detector 1506 may be configured to set the updated Tx parameter settings to configure a time duration of the Tx radar signal to be identical to, or similar to, a time duration of the interference signal, e.g., with up to a 20% variance or any other variance.

In another example, the interference detector 1506 may be configured to set the updated Tx parameter settings to configure; the slope of the Tx radar signal to be identical to, or similar to, a slope of the interference signal, e.g., with up to a 30% variance or any other variance.

In another example, the interference detector 1506 may be configured to set the updated Tx parameter settings to configure the bandwidth of the Tx radar signal to be identical to, or similar to, a bandwidth of the interference signal.

In some demonstrative aspects, processor 1440 (FIG. 14) may be configured, for example, to perform one or more operations and/or functionalities of, the radar data-path processing 1504 and/or the interference detector 1506. For example, processor 1440 (FIG. 14) may be configured to aggregate interference information including inputs on interference type and/or one or more interference Tx parameters, and to feedback an instruction to the RF frontend 1430 FIG. 14), for example, to configure the setting of the one or more Tx parameters, e.g., to match the interference Tx parameter estimation.

In some demonstrative aspects, interference detector 1506 may be configured to feedback to RF frontend 1502 information to configure a time shift, e.g., a jitter or any other random or pseudo-random time-shift, to be applied to a start time of each Tx radar frame.

In some demonstrative aspects, the time shift may be utilized to ensure that a detection corresponding to the interferer in a radar detection result may be detectable, e.g., by radar detector 1450 (FIG. 14), as a non-valid detection, for example, a ghost target, e.g., as described above.

In one example, there may also be a natural jitter effect on the location of the detection corresponding to the interferer, e.g., the ghost location, between frames. This natural jitter effect may result, for example, from an environment of the radar device implementing the processing scheme 1500.

In some demonstrative aspects, matching and/or correlating the updated setting of the one or more Tx parameters to the interference Tx parameter estimation may result in switching between a first radar processing scenario, e.g., a 4D full noise floor scenario, and a second radar processing scenario, e.g., a non-valid detection scenario (ghost target scenario). For example, the 4D full noise floor scenario may be characterized by a noise floor, which may be relatively high, e.g., due to the interference. For example, the non-valid detection scenario may be characterized by a relatively low noise floor, e.g., compared to the noise floor of the 4D full noise floor scenario. For example, the non-valid detection scenario may be characterized by a relatively clear appearance of the detection corresponding to the interferer, e.g., as a ghost target.

In one example, aggregating and/or collecting the radar data to determine the interference Tx parameter estimation may be performed, for example, by a parallel block, e.g., in real time, for example, to achieve a fast reaction time to react to the current interferer modulation parameters, e.g., for one or more next frames.

In some demonstrative aspects, the updated Tx parameter settings may be configured to include one or more modulation type parameters, which may define, for example, switching between different modulation types. For example, processor 1440 (FIG. 14) may be configured to generate the updated Tx parameter settings to switch between modulation types, for example, based side level info of the processed radar data 1507, for example, to achieve an improved noise shaping of the radar frame.

In some demonstrative aspects, the radar data-path processing 1504 may provide point cloud radar information 1513, which may be based on Tx radar signals transmitted according to the updated Tx parameter setting.

In some demonstrative aspects, processor 1440 (FIG. 14) may be configured to determine the updated Tx parameter settings, for example, to reduce an impact of the interference signal on a noise floor of the point cloud radar information 1513, e.g., as described below.

In some demonstrative aspects, point cloud radar information 1513 may include improved frames having one or more non-valid detections, which may jump from frame to frame, for example, instead of a high noise floor.

In some demonstrative aspects, a radar detector 1510 may be configured to filter the non-valid detections in the improved frames, e.g., with time, for example, when considering cross-frame overall data.

In some demonstrative aspects, processor 1440 (FIG. 14) may be configured to detect the interference Tx parameter estimation corresponding to the interferer, for example, while tuning the setting one or more, e.g., some or all, of the Tx parameters of transmitter 1483 (FIG. 14), for example, to substantially match the interference Tx parameter estimation.

In some demonstrative aspects, the process of updating the setting of the one or more Tx parameters of transmitter 1483 (FIG. 14) based on the interference Tx parameter estimation may support achieving a higher correlation between the interference signal and Tx radar signals transmitted from transmitter 1483 (FIG. 14). This correlation between the interference signal and Tx radar signals transmitted from transmitter 1483 (FIG. 14) may support focusing the interference energy on one or more relatively small 4D bins of the point cloud radar information 1513.

In some demonstrative aspects, interference detector 1506 may be configured to determine the updated Tx parameter settings 1509, for example, to create, e.g., on purpose, a non-valid detection, e.g., a ghost target, for example, corresponding to the interference signal, e.g., as described above.

In some demonstrative aspects, the non-valid detection, e.g., the ghost target, may appear to jump between frames, for example, since a relative time of the interference relative to the radar device, e.g., in terms of time, speed, location, and/or angle, may change every frame.

In some demonstrative aspects, the change in the location of the ghost target jumping between frames may support filtering the ghost target by the radar tracker, e.g., radar tracker 1450 (FIG. 14). As a result, the interference may be mitigated and/or eliminated, e.g., totally eliminated.

In one example, processor 1440 (FIG. 14) may apply jitter on a start of a frame, e.g., using a pseudo random sequence, a pseudo random shift, an unpredictable shift, or any other method, for example, to confirm that the location of the ghost target will appear to jump between the frames.

In some demonstrative aspects, radar processing scheme 1500 may be configured for a single interferer scenario, and/or for a multi-interferer scenario. For example, any super position signal may be used to shape the noise optimally, for example, to minimize a number of RBs affected by one or more interferes. Accordingly, radar processing scheme 1500 may be suitable, for example, even for a multi-interferer scenario.

In some demonstrative aspects, radar processing scheme 1500 may be based on a synergy between two layers of a radar system, e.g., a first layer including the RF compute path, e.g., at the data processing path 1504, and a second layer including the radar tracker 1510.

In some demonstrative aspects, the first layer including the RF compute path may be utilized to reduce the noise floor from the entire 4D cube, e.g., the point cloud radar information 1513, for example, by matching and/or correlating the updated setting of the one or more Tx parameters to the interference Tx parameter estimation, e.g., as described above. As a result, relatively good radar KPIs may be maintained, for example, while “creating” non-valid detections corresponding to one or more interferers.

In some demonstrative aspects, the second layer including the radar detector, e.g., radar detector 1450, may be utilized to cancel the non-valid detections.

In some demonstrative aspects, this synergy between the RF compute path and the radar detector may be utilized to maintain performance of the radar, e.g., with minimal impact due to the interference.

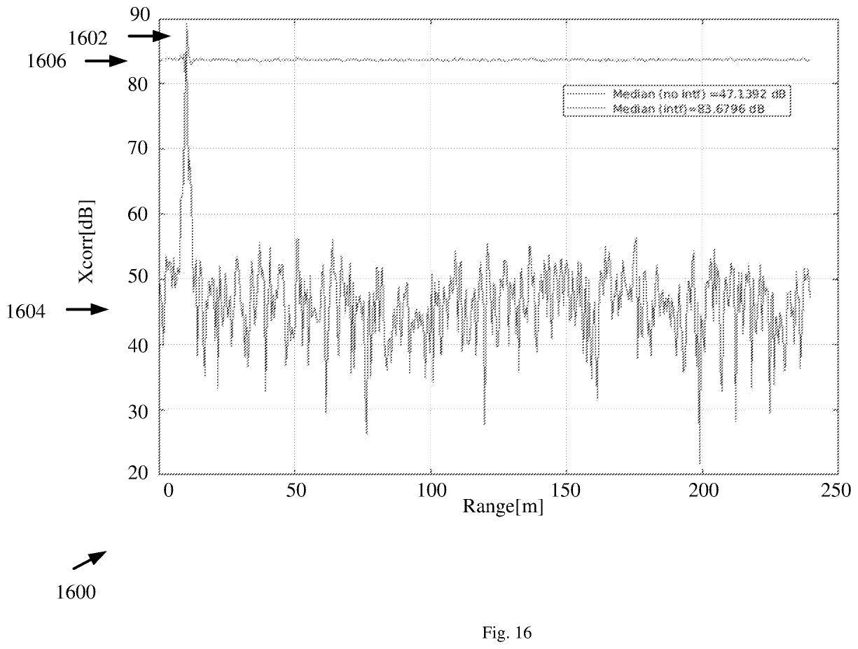

Reference is made to FIG. 16, which schematically illustrates a range response 1600, to demonstrate a technical problem, which may be addressed in accordance with some demonstrative aspects.

In one example, range response 1600 may be based on radar Rx signals including a reflection 1602 from a real target.

In some demonstrative aspects, the radar Rx signals may be based on Tx radar signals, which are transmitted according to a Tx parameter setting.

As shown in FIG. 16, a noise floor level 1604 of range response 1600 may be minimal, for example, when radar Rx signals are not affected by an interference signal.

As shown in FIG. 16, a noise floor level 1606 of range response 1600 may be high, for example, when the radar Rx signals are affected by an interference signal and the Tx parameter setting is not coherent with the interference signal.

In one example, the noise floor 1606 may result from a difference between the Tx parameter setting of the Tx radar signals and the Tx parameters of the interference signal, for example, in terms of a different BW, a different slope, a different modulation type, a different time duration and/or a different coding.

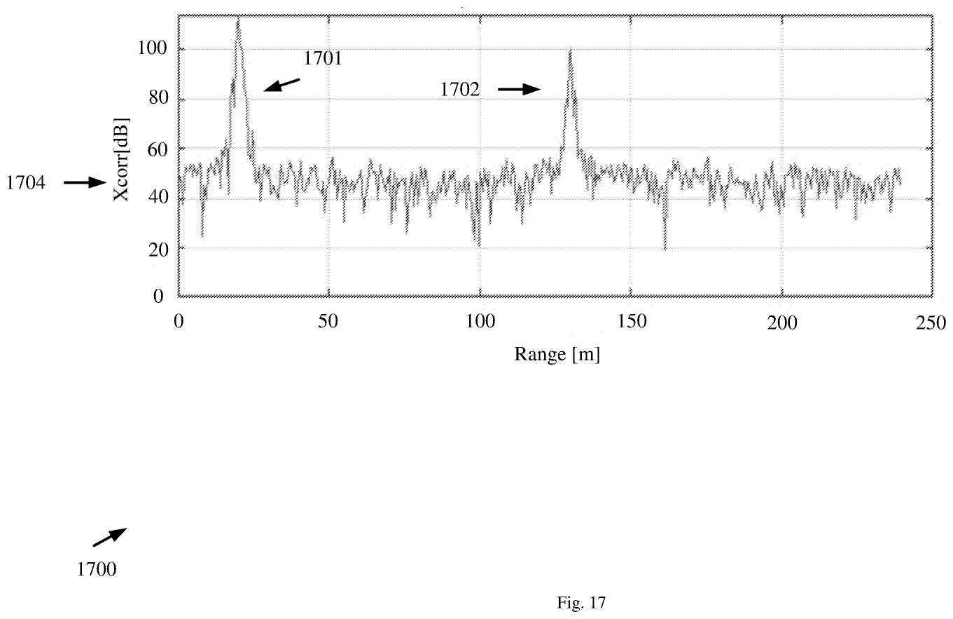

Reference is made to FIG. 17, which schematically illustrates a range response 1700 based on Rx radar signals received by a radar device, in accordance with some demonstrative aspects.

In one example, range response 1700 may be based on the radar Rx signals received by RF frontend 1430 (FIG. 14).

In some demonstrative aspects, the radar Rx signals may be affected by an interference signal from an interferer.

In some demonstrative aspects, the radar Rx signals may be based on Tx radar signals, which may be transmitted by RF frontend 1430 (FIG. 14) according to a Tx parameter setting.

In some demonstrative aspects, the Tx parameter setting may be configured to be substantially coherent with an interference Tx parameter estimation of the interference signal, e.g., as described above. For example, a Tx parameter setting of the radar Tx signals may be configured to be similar to, or identical to, the interference Tx parameter estimation of the interference signal, for example, in terms of a same or similar BW, a same or similar slope, a same or similar modulation type, e.g., a Compact Time Division Multiplex (CTDM) or FMCW, a same or similar time duration, and/or a same or similar coding.

In some demonstrative aspects, as shown in FIG. 17, range response 1700 may include a real target, which may appear as a peak 1701.

In some demonstrative aspects, as shown in FIG. 17, the interference signal may appear as a ghost target 1702.

In some demonstrative aspects, as shown in FIG. 17, a noise floor level 1704 of range response 1700 may be relatively low, e.g., minimal, for example, compared to a level of the peaks 1701 and 1702.

In some demonstrative aspects, adjusting the Tx parameter setting, for example, to match and/or be correlated with the interference Tx parameters may result in appearance of the ghost target 1702. However, the impact of the ghost target 1702 may not be as severe as an impact of the high noise floor, e.g., noise floor level 1606 (FIG. 16), on the 4D information.

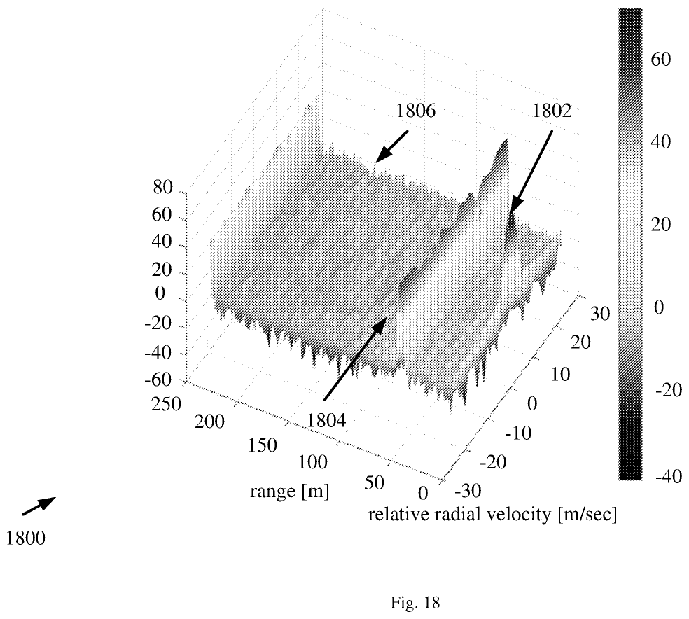

Reference is made to FIG. 18, which schematically illustrates a range-Doppler response 1800 based on Rx radar signals received by a radar device, in accordance with some demonstrative aspects.

In one example, range-Doppler response 1800 may be based on the radar Rx signals received by RF frontend 1430 (FIG. 14).

In some demonstrative aspects, the radar Rx signals may be affected by an interference signal from an interferer.

In some demonstrative aspects, the radar Rx signals may be affected by an interference signal from an interferer.

In some demonstrative aspects, the radar Rx signals may be based on Tx radar signals, which may be transmitted by RF frontend 1430 (FIG. 14) according to a Tx parameter setting.

In some demonstrative aspects, the Tx parameter setting may be configured to be substantially coherent with an interference Tx parameter estimation of the interference signal, e.g., as described above. For example, a Tx parameter setting of the radar Tx signals may be configured to be similar to, or identical to, the interference Tx parameter estimation of the interference signal, for example, in terms of a same or similar BW, a same or similar slope, a same or similar time duration, and/or a same or similar modulation type.

In some demonstrative aspects, a modulation type of the Tx parameter setting of the radar Tx signals may be different than the modulation type of the interference signal. For example, a Tx parameter setting of the radar Tx signals may be according to a wideband (WB) modulation, e.g., CTDM, while the modulation type of the interference may be according to a FMCW scheme, e.g., with different phase coding, slope, duration and/or BW.

In some demonstrative aspects, as shown in FIG. 18, a real target may appear as a peak 1802 in a specific range-Doppler bin of range-Doppler response 1800.

In some demonstrative aspects, as shown in FIG. 18, the interference signal may spread in a specific Range Bin (RB) 1804 as a noise floor, for example, due to a random slow time coding between repetitive chirps. For example, some or all timing and/or slope parameters of the interference signal may match Tx parameters of the radar Tx signals, for example, in case the interferer (aggressor) and the radar device (victim) use FMCW or CTDM waveform modulations.

In some demonstrative aspects, as shown in FIG. 18, the interference signal may only spread in the specific RB 1804, for example, in a same RB where a ghost target should appear in a range-response, e.g., if the coding scheme were to be the same.

In some demonstrative aspects, as shown in FIG. 18, a noise floor level 1806 of range-Doppler response 1800 may remain minimal, e.g., except for in the specific range bin 1804.

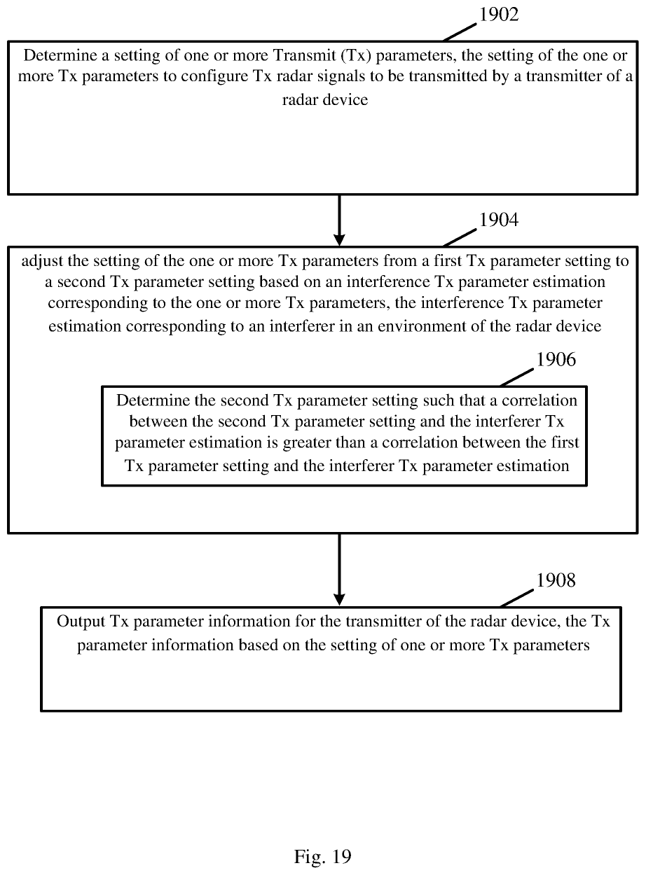

Reference is made to FIG. 19, which schematically illustrates a method of determining a setting of one or more Tx parameters for transmitting radar Tx signals, in accordance with some demonstrative aspects. For example, one or more of the operations of the method of FIG. 19 may be performed by a radar system, e.g., radar system 900 (FIG. 9), a radar device, e.g., radar device 101 (FIG. 1), radar device 800 (FIG. 8), and/or radar device 910 (FIG. 9); a processor, e.g., processor 1440 (FIG. 14), radar processor 834 (FIG. 8), and/or baseband processor 930 (FIG. 9); and/or a controller, e.g., controller 950 (FIG. 9).

As indicated at block 1902, the method may include determining a setting of one or more Tx parameters, the setting of the one or more Tx parameters to configure Tx radar signals to be transmitted by a transmitter of a radar device. For example, processor 1440 (FIG. 14) may determine the setting of the one or more Tx parameters to configure the Tx radar signals to be transmitted by the transmitter 1483 (FIG. 14), e.g., as described above.

As indicated at block 1904, the method may include adjusting the setting of the one or more Tx parameters from a first Tx parameter setting to a second Tx parameter setting based on an interference Tx parameter estimation corresponding to the one or more Tx parameters, the interference Tx parameter estimation corresponding to an interferer in an environment of the radar device. For example, processor 1440 (FIG. 14) may adjust the setting of the one or more Tx parameters from the first Tx parameter setting to the second Tx parameter setting based on the interference Tx parameter estimation corresponding to the one or more Tx parameters, the interference Tx parameter estimation corresponding to the interferer in the environment of the transmitter 1483 (FIG. 14), e.g., as described above.

As indicated at block 1906, adjusting the setting of the one or more Tx parameters may include determining the second Tx parameter setting such that a correlation between the second Tx parameter setting and the interferer Tx parameter estimation is greater than a correlation between the first Tx parameter setting and the interferer Tx parameter estimation. For example, processor 1440 (FIG. 14) may determine the second Tx parameter setting such that the correlation between the second Tx parameter setting and the interferer Tx parameter estimation may be greater than the correlation between the first Tx parameter setting and the interferer Tx parameter estimation, e.g., as described above.

As indicated at block 1908, the method may include outputting Tx parameter information for the transmitter of the radar device, the Tx parameter information based on the setting of one or more Tx parameters. For example, processor 1440 (FIG. 14) may be configured to cause output 1442 (FIG. 14) to output the Tx parameter information 1446 (FIG. 14) for the transmitter 1483 (FIG. 14) based on the setting of the one or more Tx parameters, e.g., as described above.

Referring back to FIG. 9, in some demonstrative aspects, there may be a need to provide a technical solution to mitigate radio interference between radar devices, for example, radio interference at radar devices of vehicle 900 (FIG. 9), which may be caused by radar communications from other radar devices, e.g., of other vehicles, and/or one or more other radar communication sources, e.g., as described below.

In one example, reliability and/or immunity in the presence of an interference signal may be a challenging requirement from an automotive radar system, e.g., radar system 901.

In some demonstrative aspects, an interference signal may include a spoofing signal from a radar spoofer, e.g., as described below.

In some demonstrative aspects, there may be a need to provide a technical solution to detect a spoofing signal from a radar spoofer (also referred to as a “aggressor radar”), e.g., as described below.

In some demonstrative aspects, a spoofing signal may have one or more, e.g., some or all, same characteristics or similar characteristics as signals being communicated by a radar device (also referred to as a “victim radar”), e.g., device 910.

In one example, the characteristics of the radar signals may include, for example, a carrier frequency of the radar signals, a chirp BW of a chirp of the radar signals, a duration of the radar signals, a slope of the radar signals, a slow coding of the radar signals, a correlation in BW, a modulation, and/or any other parameter.

For example, one or more characteristics of the spoofing signal from the aggressor radar may be similar to or identical to one or more characteristics of the radar signal of the victim radar. In one example, a carrier frequency of the spoofing signal may be similar to or identical to a carrier frequency of the radar signal of the victim radar; a chirp BW of the spoofing signal may be similar to or identical to a chirp BW of the radar signal of the victim radar; a duration of the spoofing signal may be similar to or identical to a duration of the radar signal of the victim radar, e.g., up to a 20% difference or any other difference; a slope of the spoofing signal may be similar to or identical to a slope of the radar signal of the victim radar, e.g., up to 30% difference or any other difference; a slow coding of the spoofing signal may be similar to or identical to a slow coding of the radar signal of the victim radar; and/or a modulation of the spoofing signal may be similar to or identical to a modulation of the radar signal of the victim radar.

In some demonstrative aspects, the spoofing signal may disturb a radar system, e.g., radar system 901, and/or may create an appearance of one or more ghost targets, which may result in wrong decision making, e.g., based on wrong data, for example, if the spoofing signal is not identified or mitigated.

In one example, the spoofing signal may cause a false emergency break, for example, if the spoofing signal causes a radar device to “think” that an object exists in the way, when actually there is no object.

In some demonstrative aspects, there may be a need to provide a technical solution, which may support reliable and robust imaging radar for an AV, e.g., as described below.

In some demonstrative aspects, there may be a need to provide a technical solution, which may support detection of radar spoofers, and/or an identification of the radar spoofers, for example, to allow mitigating and/or ignoring the ghost targets generated by spoofing signals.

In some demonstrative aspects, for example, in some use cases, scenarios, and/or implementations, there may be one or more disadvantages, inefficiencies, and/or technical problems in implementing detection methods for detection of spoofing signals based on received power. For example, these detection methods may rely on estimation of a power of a reflection. For example, an attenuation factor difference between a real target reflection and a direct interference may be estimated, for example, based on processing of several radar frames. For example, the attenuation factor estimation may be based on the fact that real target reflections may be based on a two-way travel, e.g., corresponding to a range factor of R\hat{ }4, while direct interferences may be based on a one-way travel, e.g., corresponding to a range factor of R\hat{ }2.

In one example, a measurement of the received power, e.g., based on several frames, may assume some stationarity of the radar spoofer, and/or may be very noisy. For example, the Signal-to-Noise-Ratio (SNR) may not remain constant during driving, e.g., due to the nature of scattered target Radar Cross Section (RCS) deviation over time. Accordingly, this measurement may not be very accurate and/or reliable.

In another example, detection methods, which are based on the received power, may be performed in the RD domain, and, therefore, may be agnostic to an AoA of the radar spoofer. Accordingly, these detection methods may not be suitable to detect the radar spoofer, for example, when a real target and the radar spoofer are both at substantially as same range.

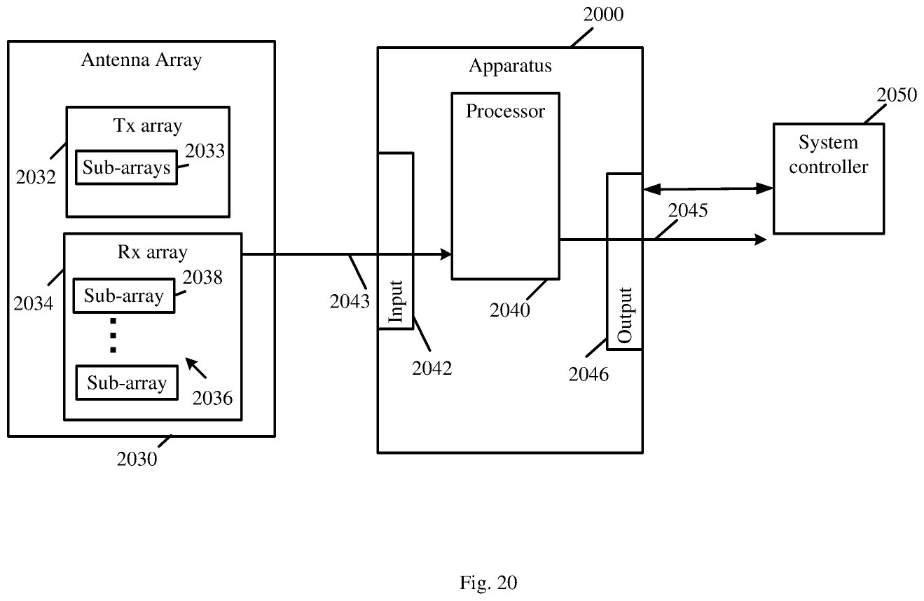

Reference is made to FIG. 20, which schematically illustrates a processor apparatus 2000, in accordance with some demonstrative aspects.

In some demonstrative aspects, apparatus 2000 may be configured to detect a spoofing signal at a radar device, e.g., as described below.

In some demonstrative aspects, apparatus 2000 may be implemented, for example, as part of a radar device, e.g., a radar device 910 (FIG. 9).

In some demonstrative aspects, apparatus 2000 may be implemented, for example, as part of a controller, e.g., controller 950 (FIG. 9).

In some demonstrative aspects, apparatus 2000 may be implemented, for example, as part of a radar processor, e.g., radar processor 834 (FIG. 8), and/or BB processor 930 (FIG. 9).

In some demonstrative aspects, apparatus 2000 may include an input 2042 configured to receive radar Rx data 2043 corresponding to radar Rx signals received by an Rx antenna array 2034, for example, based on radar Tx signals transmitted from a Tx antenna array 2032, e.g., as described below.

In some demonstrative aspects, radar Rx data 2043 may include raw radar data corresponding to the radar Rx signals received by the Rx antenna array 2034.

In some demonstrative aspects, radar Rx data 2043 include processed radar data, which may be provided, for example, by another processor of a radar system. In one example, Radar Rx data 2043 may be generated and/or provided by processor 836 (FIG. 8), for example, based on the radar Rx data 811 (FIG. 1). In another example, Radar Rx data 2043 may be generated and/or provided by BB processor 930 (FIG. 9), for example, based on radar signals communicated by the radar device 910 (FIG. 9).

In other aspects, Radar Rx data 2043 may be generated and/or provided by any other element of a radar device and/or a radar system, e.g., radar device 800 (FIG. 8) and/or radar system 901 (FIG. 9).

In some demonstrative aspects, the Radar Rx data 2043 may be based on radar Rx data 811 (FIG. 8).

In one example, processor 836 (FIG. 8) may be configured to provide the radar Rx data 2043 to input 2042.

In some demonstrative aspects, Tx array 2032 and/or Rx array 2034 may be implemented and/or included as part of an antenna array 2030.

In some demonstrative aspects, antenna array 2030 may include a MIMO antenna array. For example, MIMO antenna array 881 (FIG. 8) may include one or more elements of antenna array 2030, and/or may perform one or more operations and/or functionalities of antenna array 2030; Tx arrays 824 (FIG. 8) may include one or more elements of Tx array 2032, and/or may perform one or more operations and/or functionalities of Tx array 2032; and/or Rx arrays 826 (FIG. 8) may include one or more elements of Rx array 2034, and/or may perform one or more operations and/or functionalities of Rx array 2034.

In some demonstrative aspects, apparatus 2000 may include a processor 2040 configured to detect whether the radar Rx signals are subject to an interference signal. For example, radar processor 834 (FIG. 8) may include one or more elements of processor 2040, and/or may perform one or more operations and/or functionalities of processor 2040; BB processor 930 (FIG. 9) may include one or more elements of processor 2040, and/or may perform one or more operations and/or functionalities of processor 2040; and/or controller 950 (FIG. 9) may include one or more elements of processor 2040, and/or may perform one or more operations and/or functionalities of processor 2040.

In other aspects, processor 2040 may be implemented as part of any other, dedicated, or indicated, element of a radar device, e.g., radar device 800 (FIG. 8) or radar device 910 (FIG. 9), and/or a radar system, e.g., radar system 901 (FIG. 9).

In some demonstrative aspects, processor 2040 may include, or may be implemented, partially or entirely, by circuitry and/or logic, e.g., one or more processors including circuitry and/or logic, memory circuitry and/or logic. Additionally or alternatively, one or more functionalities of processor 2040 may be implemented by logic, which may be executed by a machine and/or one or more processors, e.g., as described below.

In some demonstrative aspects, processor 2040 may be configured to detect whether the radar Rx signals, which are received by Rx array 2034, are subject to an interference signal, for example, based on a radar scheme implemented for communicating and/or processing the radar signals communicated via antenna array 2030, e.g., as described below.

In some demonstrative aspects, the radar scheme may be based on a structure of a MIMO radar virtual array corresponding to antenna array 2030, e.g., as described below.

In some demonstrative aspects, antenna array 2030 may be configured to provide a MIMO radar virtual array including a uniformly spaced virtual array, e.g., a virtual Uniform Linear Array (ULA).

In other aspects, any other MIMO radar virtual array may be implemented.

In some demonstrative aspects, the MIMO radar virtual array may be constructed based on a plurality of Tx sub-arrays 2033 of the Tx array 2032, and/or a plurality of Rx sub-arrays 2036 of the Rx array 2034.

In some demonstrative aspects, some or all of the plurality of Tx sub-arrays 2033 may include uniformly-spaced antennas, for example, although Tx array 2032 may not include a uniformly spaced antenna array; and/or some or all of the plurality of Rx sub-arrays 2036 may include uniformly-spaced antennas, for example, although Rx array 2034 may not include a uniformly spaced antenna array. In one example, each Tx sub-array 2033 of the plurality of Tx sub-arrays 2033, and/or each Rx sub-arrays 2036 of the plurality of Rx sub-arrays 2036 may be configured as a uniformly spaced antenna array, e.g., a ULA.

In some demonstrative aspects, processor 2040 may be configured to detect radar spoofers according to a detection scheme, which, may be based on processing the radar Rx data 2043 with respect to a plurality of small virtual arrays, for example, corresponding to the Rx sub-arrays 2036 of the Rx array 2034, e.g., as described below.

In some demonstrative aspects, the detection scheme, which is based on a processing the radar Rx data 2043 with respect to a plurality of small virtual arrays, may be implemented to provide a technical solution to gain processing power, for example, as processing may be made on a smaller virtual array, e.g., compared to other detection methods, which may rely on a single-chain post-Doppler detection.

In some demonstrative aspects, processor 2040 may be configured to detect whether the radar Rx signals, which are received by Rx array 2034, are subject to an interference signal, for example, based on a comparison between first spectrum data and second spectrum data. For example, the first spectrum data may be based on AoA processing corresponding to the MIMO radar virtual array, e.g., based on the full Rx array 2034 and the full Tx array 2032; and/or the second spectrum data may be based on Rx AoA processing of the plurality of Rx sub-arrays 2036, e.g., as described below.

In some demonstrative aspects, processor 2040 may be configured to detect whether the radar Rx signals, which are received by Rx array 2034, are subject to the interference signal, for example, based on a difference between the first spectrum data and the second spectrum data, e.g., as described below.

In one example, a true reflection from a true target may not cause a substantial difference between the first spectrum data and the second spectrum data. However, a spoofing signal may not act according to the same spatial rules as the true reflection, e.g., from a perspective of AoA processing. Accordingly, the spoofing signal may result in a detectable difference between the first spectrum data and the second spectrum data, e.g., as described below.

In some demonstrative aspects, processor 2040 may be configured to detect radar spoofers and/or to indicate that a spoofing signal is detected, for example, based on processing of the Radar Rx data 2043, e.g., as described below.

In some demonstrative aspects, processor 2040 may be configured to detect a direction, e.g., an AoA, of the radar spoofer, e.g., as described below.

In some demonstrative aspects, processor 2040 may be configured to distinguish between “false” targets caused by a radar spoofer and one or more other targets, e.g., real targets, for example, even in a scenario where the radar spoofer resides closely with the other targets.

For example, processor 2040 may be configured to distinguish between “false” targets caused by the radar spoofer and one or more other targets, e.g., real targets, even with respect to Range Bins (RBs) which include detections caused by both the radar spoofer and real targets.

In some demonstrative aspects, processor 2040 may be configured to detect whether the radar Rx signals, which are received by Rx array 2034, are subject to an interference signal, for example, based on a first AoA spectrum and a second AoA spectrum, e.g., as described below.

In some demonstrative aspects, the interference signal may include a spoofing signal from a radar spoofer, e.g., as described below.

In some demonstrative aspects, the first AoA spectrum may be based, for example, on AoA processing of the radar Rx data 2043 according to a virtual antenna including a convolution of the Rx antenna array 2034 and the Tx antenna array 2032, e.g., as described below.

In some demonstrative aspects, the second AoA spectrum may be based, for example, on a plurality of sub-array AoA spectrums corresponding to a respective plurality of Rx antenna sub-arrays 2036 of the Rx antenna array 2034, e.g., as described below.

In some demonstrative aspects, a sub-array AoA spectrum corresponding to an Rx antenna sub-array 2038 of the plurality of Rx antenna sub-arrays 2036 may be based on AoA processing of radar Rx data 2043 corresponding to Rx signals received via the Rx antenna sub-array 2038, e.g., as described below.

In some demonstrative aspects, processor 2040 may be configured to determine the second AoA spectrum based on a combination of the plurality of sub-array AoA spectrums, e.g., as described below.

In some demonstrative aspects, processor 2040 may be configured to detect the interference signal, for example, based on a comparison between the first AoA spectrum and the second AoA spectrum, e.g., as described below.

In some demonstrative aspects, processor 2040 may be configured to detect the interference signal, for example, based on a comparison between one or more first peaks above a threshold in the first AoA spectrum and one or more second peaks above the threshold in the second AoA spectrum, e.g., as described below.

In some demonstrative aspects, processor 2040 may be configured to detect the interference signal based on a comparison between a first peak count and a second peak count, e.g., as described below.

In some demonstrative aspects, the first peak count may include a count of the one or more first peaks above the threshold in the first AoA spectrum, e.g., as described below.

In some demonstrative aspects, the second peak count may include a count of the one or more second peaks above the threshold in the second AoA spectrum, e.g., as described below.

In some demonstrative aspects, processor 2040 may be configured to detect the interference signal based on a determination that the first peak count is different from the second peak count, e.g., as described below.

In some demonstrative aspects, processor 2040 may be configured to identify a possible valid detection to be at an angle corresponding to a highest peak of all peaks in the first AoA spectrum and the second AoA spectrum, e.g., as described below.

In some demonstrative aspects, processor 2040 may be configured to identify an angle, e.g., an AoA, of the interference signal, e.g., as described below.

In some demonstrative aspects, processor 2040 may be configured to identify the interference signal to be at an angle corresponding to a peak, which appears in the second AoA spectrum and does not appear in the first AoA spectrum, e.g., as described below.

In some demonstrative aspects, the Rx antenna sub-array 2038 may include a ULA, e.g., as described below.

In one example, the Rx antenna sub-array 2038 may include a ULA with antennas having an antenna spacing of up to twice a carrier wavelength, denoted λ, e.g., 2λ, of the radar signals communicated by antenna array 2030. In other aspects, any other antenna configuration may be implemented.

In some demonstrative aspects, the virtual antenna including the convolution of the Rx antenna array 2034 and the Tx antenna array 2032 may include a ULA, e.g., as described below.

In some demonstrative aspects, processor 2040 may be configured to provide detection information 2045, for example, to identify the interference signal, e.g., as described below.

In some demonstrative aspects, apparatus 2000 may include an output 2046 to provide the detection information 2045, for example, to identify the interference signal, e.g., as described below.

In some demonstrative aspects, processor 2040 may provide the detection information 2045, for example, to a system controller 2050, e.g., via output 2046. For example, system controller 2050 may include one or more elements of controller 950 (FIG. 9) and/or vehicle controller 108 (FIG. 1), and/or may perform one or more operations and/or functionalities of controller 950 (FIG. 9) and/or vehicle controller 108 (FIG. 1).

In some demonstrative aspects, processor 2040 may provide the detection information 2045, for example, to any other components or elements of a radar device, e.g., radar device 910 (FIG. 9) and/or radar device 800 (FIG. 8), and/or a radar system, e.g., radar system 901 (FIG. 9), for example, via output 2046.

In one example, processor 2040 may be configured to report detection information 2045 to one or more higher layers of a radar system, e.g., to system controller 2050, for example, when a radar spoofer is detected and/or identified, e.g., as described below.

In some demonstrative aspects, the higher layers of the radar system may be configured to perform one or more operations, for example, based on the detection information 2045.

In one example, the higher layers of the radar system, e.g., system controller 2050, may apply a null at a direction of a radar spoofer, and/or may perform any other spoofer mitigation processing, e.g., to improve accuracy. For example, the higher layers of the radar system, e.g., system controller 2050, may be configured to reduce a noise floor and/or an impact of the radar spoofing signal on potential ghost targets. For example, presence of a radar spoofer may result in an increase of the noise floor and/or may create small “weak” real targets.

In another example, the higher layers may filter the spoofing signal, for example, using an adaptive spoof canceller or the like.

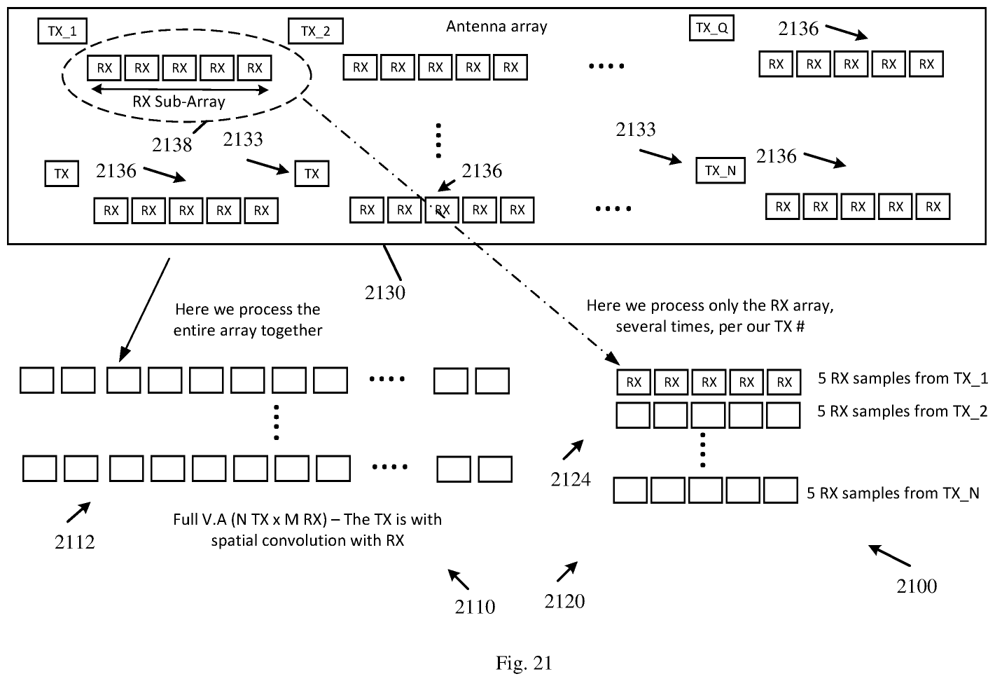

Reference is made to FIG. 21, which schematically illustrates a radar processing scheme 2100 to process radar Rx data corresponding to radar Rx signals received by an antenna array 2130, in accordance with some demonstrative aspects. For example, antenna array 2030 (FIG. 20) may include one or more elements of antenna array 2130, and/or may perform one or more operations and/or functionalities of antenna array 2130.

In one example, processor 2040 (FIG. 20) may perform one or more operations and/or functionalities of radar processing scheme 2100, for example, to process radar Rx data 2043 (FIG. 20).

In some demonstrative aspects, antenna array 2130 may include a MIMO radar antenna.

In some demonstrative aspects, as shown in FIG. 21, antenna array 2130 may include a Tx array including a plurality of Tx sub-arrays 2133.

In some demonstrative aspects, as shown in FIG. 21, antenna array 2130 may include an Rx array including a plurality of Rx sub-arrays 2136.

In some demonstrative aspects, as shown in FIG. 21, an Rx antenna sub-array 2138, e.g., each Rx sub-array 2136, may include a ULA, e.g., having antenna elements uniformly spaced from one another.

In some demonstrative aspects, as shown in FIG. 21, radar processing scheme 2100 may include a first processing scheme 2110, for example, AoA processing based on a virtual antenna 2112 including a convolution of the Rx antenna array and the Tx antenna array.

In some demonstrative aspects, first processing scheme 2110 may be configured to determine a First AoA spectrum, for example, based on the virtual antenna 2112.

In some demonstrative aspects, as shown in FIG. 21, the virtual antenna 2112 including the convolution of the Rx antenna array and the Tx antenna array 2132 may include a ULA. For example, the virtual antenna 2112 may include antenna elements uniformly spaced.

In some demonstrative aspects, processor 2040 (FIG. 20) may perform AoA processing according to first processing scheme 2110, for example, by performing AoA processing based on the virtual antenna 2112, for example, to determine the first AoA spectrum.

In some demonstrative aspects, as shown in FIG. 21, radar processing scheme 2100 may include a second processing scheme 2120, for example, an Rx sub-array AoA processing scheme, which may be based on a plurality of sub-array AoA spectrums corresponding to the plurality of Rx antenna sub-arrays 2136.

In some demonstrative aspects, second processing scheme 2120 may be implemented to determine a second AoA spectrum, for example, based on the plurality of sub-array AoA spectrums corresponding to the plurality of Rx antenna sub-arrays 2136.

In some demonstrative aspects, a sub-array AoA spectrum corresponding to an Rx antenna sub-array 2138 may be based on Rx AoA processing 2124 of radar Rx data corresponding to Rx signals received via the Rx antenna sub-array 2138.

In some demonstrative aspects, the second AoA spectrum may be determined, for example, based on a combination of the plurality of sub-array AoA spectrums corresponding to the plurality of Rx antenna sub-arrays 2136.

In some demonstrative aspects, processor 2040 (FIG. 20) may be configured to perform Rx AoA processing 2124 for each of the plurality of Rx antenna sub-arrays 2136, for example, do determine the plurality of sub-array AoA spectrums. For example, processor 2040 (FIG. 20) may be configured to determine the second AoA spectrum based on a combination of the plurality of sub-array AoA spectrums.

In some demonstrative aspects, as shown in FIG. 21, Rx AoA processing 2124 may include processing of radar Rx data corresponding to Rx antenna sub-array 2138 several times, e.g., per each Tx sub-array 2133, for example, to determine the sub-array AoA spectrum corresponding to the Rx signals received via the Rx antenna sub-array 2138.

In some demonstrative aspects, radar processing scheme 2100 may be based on a structure of antenna array 2130.

In some demonstrative aspects, as shown in FIG. 21, the virtual array 2112, e.g., resulting from the spatial/geometric convolution between the Tx array and the Rx array geometry, may be uniformly spaced. For example, the Rx array may not be required to include a uniformly spaced array, and/or the Tx array may not be required to include a uniformly spaced array.

In some demonstrative aspects, in a case of a true target, a transmitted signal, which is transmitted via the Tx antenna sub-arrays 2133, may hit the target and may be reflected back to Rx antenna sub-arrays 2136. Accordingly, the first AoA spectrum resulting from AoA processing of the signal received by Ntx*Nrx channels of the virtual antenna array 2112 may include a single peak, e.g., corresponding to the true target.

In some demonstrative aspects, in a case of a radar spoofer that transmits a spoofing signal received by antenna array 2130, the spoofing signal may be equivalent to a signal transmitted by one Tx antenna and received by all Nrx antennas. Accordingly, the first AoA spectrum resulting from the AoA processing of the spoofing signal received by the Ntx*Nrx channels of the virtual antenna array 2112 may include a spectrum with increased Side Lobe Levels (SLL), e.g., as MIMO radar equations for the virtual antenna array 2112 may not be correct with respect to the spoofing signal.

In some demonstrative aspects, processing the radar Rx data according to second processing scheme 2100 may be based on a configuration of each Rx antenna sub-array 2136 as a uniformly spaced antenna array. For example, Rx antenna sub-array 2136 may be configured to have a uniform spacing, e.g., of up to half a wavelength of the Rx signals, between adjacent antenna elements of Rx antenna sub-array 2136.

In some demonstrative aspects, as shown in FIG. 21, processing the radar Rx data according to second processing scheme 2120 may include coherent AoA processing for each smaller Rx sub-array separately, e.g., separate Rx AoA processing 2124 for each Rx sub-array 2136.

In some demonstrative aspects, processing the radar Rx data according to second processing scheme 2120 may include combining AoA processing results of the a plurality of separate Rx AoA processes 2124 corresponding to the plurality of Rx sub-arrays 2136, for example, in a non-coherent manner, e.g., based on magnitude summation.

In some demonstrative aspects, processing the radar Rx data according to second processing scheme 2120 may provide a technical solution to overcome the increased SLL, e.g., resulting from the spoofing signal.

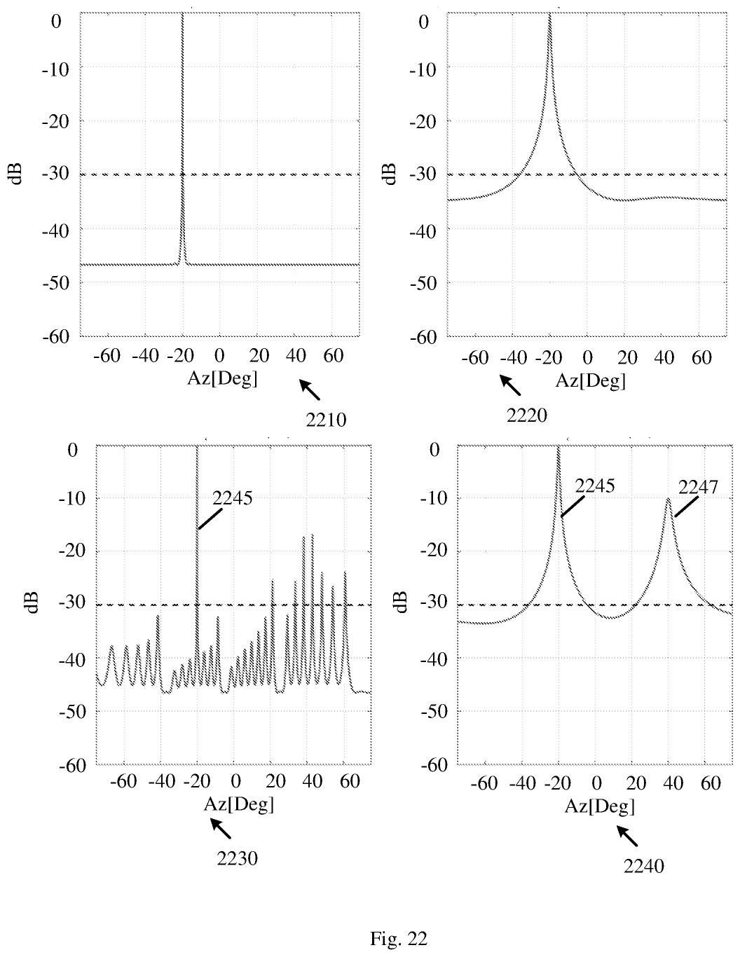

Reference is made to FIG. 22, which schematically illustrates a plurality of AoA spectrums, in accordance with some demonstrative aspects.

In some demonstrative aspects, a first AoA spectrum 2210 may be based on AoA processing of first radar Rx data according to virtual antenna 2112 (FIG. 21).

In some demonstrative aspects, a second AoA spectrum 2220 may be based on a plurality of sub-array AoA spectrums determined by processing the first radar Rx data with respect to the plurality of Rx antenna sub-arrays 2136 (FIG. 21).

In some demonstrative aspects, the first radar Rx data resulting in the first AoA spectrum 2210 and the second AoA spectrum 2220 may correspond to a first scenario including a single true target, e.g., without presence of a radar spoofer.

In some demonstrative aspects, as shown in FIG. 22, the first AoA spectrum 2210 and the second AoA spectrum 2220 depict similar results, for example, indicating similar possible detections, for example, a possible target at an angle of −20 degrees, e.g., corresponding to the true target.

In some demonstrative aspects, a third AoA spectrum 2230 may be based on AoA processing of second radar Rx data according to virtual antenna 2112 (FIG. 21).

In some demonstrative aspects, a fourth AoA spectrum 2220 may be based on a plurality of sub-array AoA spectrums determined by processing the second radar Rx data with respect to the plurality of Rx antenna sub-arrays 2136 (FIG. 21).

In some demonstrative aspects, the second Rx data resulting in the third AoA spectrum 2230 and the fourth AoA spectrum 2240 may correspond to a second scenario including the single true target and a radar spoofer.

In some demonstrative aspects, as shown in FIG. 22, the third AoA spectrum 2230 and the fourth AoA spectrum 2240 depict different results, e.g., dur to the presence of the radar spoofer.

In some demonstrative aspects, as shown in FIG. 22, the third AoA spectrum 2230 may include many false detections, e.g., many peaks, for example, due to high SLL resulting from radar spoofing signals generated by the radar spoofer.

In some demonstrative aspects, as shown in FIG. 22, the fourth AoA spectrum 2240 may include only two detections. For example, the two detections may include a detection, e.g., a Space Object Identification (SOI), corresponding to the true target at an angle of −20 degrees, and a detection corresponding to the radar spoofer at 40 degrees, e.g., the AoA of the radar spoofer.

In some demonstrative aspects, as shown in FIG. 22, a comparison between the third AoA spectrum 2230 and the fourth AoA spectrum 2240 may identify a radar spoofing signal from radar spoofer.

In some demonstrative aspects, as shown in FIG. 22, a comparison between the third AoA spectrum 2230 and the fourth AoA spectrum 2240 may identify the AoA of the radar spoofer.

In some demonstrative aspects, a spoofer detection process, for example, based on the comparison between the third AoA spectrum 2230 and the fourth AoA spectrum 2240 may include one or more operations, e.g., as described below. In one example, a processor, e.g., processor 2040 (FIG. 20) may be configured to perform one or more, e.g., some or all, of the operations of the spoofer detection process described below.

In some demonstrative aspects, the spoofer detection process may include receiving radar Rx data of a radar frame, e.g., the radar Rx data 2043 (FIG. 20).

In some demonstrative aspects, the spoofer detection process may include performing two different types of AoA processing, for example, in parallel, e.g., based on the radar Rx data of the radar frame.

In some demonstrative aspects, the spoofer detection process may include performing a first AoA processing, e.g., based on AoA processing of radar Rx data according to virtual antenna 2112 (FIG. 21), for example, to determine a first AoA spectrum, e.g., AoA spectrum 2230.

In some demonstrative aspects, the spoofer detection process may include performing a second AoA processing, e.g., the Rx AoA processing, for example, based on the plurality of sub-array AoA spectrums corresponding to the plurality of Rx antenna sub-arrays 2136 (FIG. 21), for example, to determine a second AoA spectrum, e.g., AoA spectrum 2240.

In some demonstrative aspects, the spoofer detection process may include counting a number of peaks above a threshold, e.g., a threshold of −25 dB or any other threshold, in the first AoA spectrum and in the second AoA spectrum.

In some demonstrative aspects, the spoofer detection process may include identifying a spoofing signal, for example, based on the number of peaks above the threshold in the in the first AoA spectrum and in the second AoA spectrum.

In some demonstrative aspects, the spoofer detection process may include determining that a spoofing signal from a radar spoofer is not present in the radar frame, for example, based on a determination that the number of peaks above the threshold in the first AoA spectrum is equal to the number of peaks above the threshold in the second AoA spectrum.

In some demonstrative aspects, if the number of peaks above the threshold in the first AoA spectrum and in the second AoA spectrum is different, there is a radar spoofer.

In one example, a difference between the number of peaks in the first AoA spectrum and the number of peaks in the second AoA spectrum may vary. Accordingly, a detection criterion to detect the spoofer signal may be based, for example, on a noise floor of the first AoA spectrum and/or the second AoA spectrum, the number of peaks in the first AoA spectrum and/or the second AoA spectrum, locations of the peaks, e.g., in an Azimuth (Az) and/or Elevation (El) dimension, and/or a strength of the peaks.

In some demonstrative aspects, processor 2040 (FIG. 20) may be configured to determine a location of a possible target, e.g., a location of an SOI, based on a peak, e.g., highest peak, which is detected in both the first AoA spectrum and the second AoA spectrum. For example, processor 2040 (FIG. 20) may determine the location of the possible target to be at −20 degrees, for example, based on a peak 2245, which is over a threshold, e.g., of −30 dB, and which may be identified in both AoA spectrum 2230 and AoA spectrum 2240.

In some demonstrative aspects, processor 2040 (FIG. 20) may be configured to determine a location of a radar spoofer based on an identified lower peak, which is included in the second AoA spectrum and not included in the first AoA spectrum. For example, processor 2040 (FIG. 20) may determine the location of the radar spoofer to be at 40 degrees, for example, based on detection of a peak 2247, which is over a threshold, e.g., of −30 dB, and which is included in AoA spectrum 2240, and not included in AoA spectrum 2230.

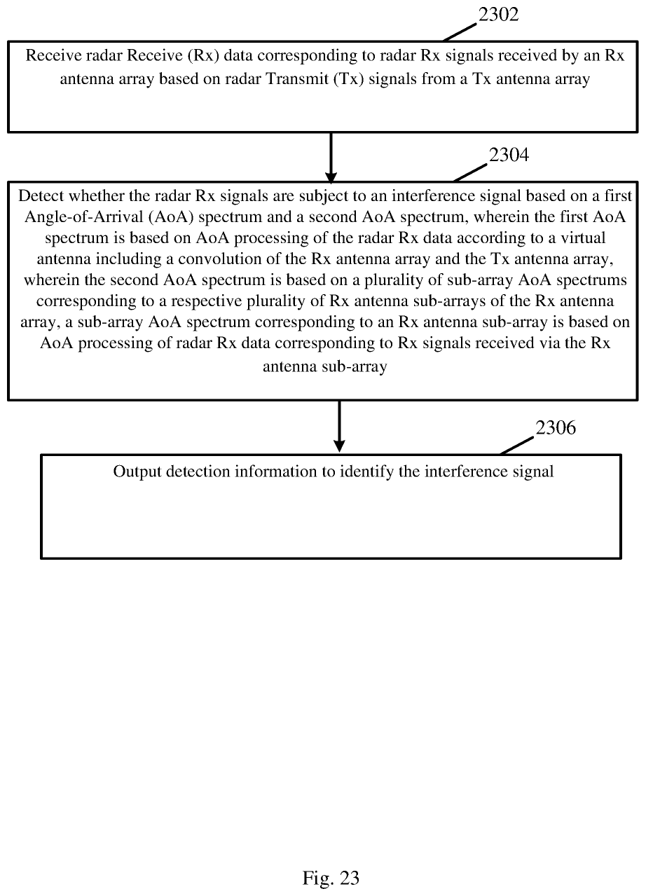

Reference is made to FIG. 23, which schematically illustrates a method of detecting whether radar Rx signals are subject to an interference signal, in accordance with some demonstrative aspects. For example, one or more of the operations of the method of FIG. 23 may be performed by a radar system, e.g., radar system 900 (FIG. 9), a radar device, e.g., radar device 101 (FIG. 1), radar device 800 (FIG. 8), and/or radar device 910 (FIG. 9); a processor, e.g., processor 2040 (FIG. 20), radar processor 834 (FIG. 8), and/or baseband processor 930 (FIG. 9); and/or a controller, e.g., controller 2050 (FIG. 20), and/or controller 950 (FIG. 9).

As indicated at block 2302, the method may include processing radar Rx data corresponding to radar Rx signals received by an Rx antenna array based on radar Tx signals from a Tx antenna array. For example, processor 2040 (FIG. 20) may receive via input 2042 (FIG. 20) radar Rx data 2043 (FIG. 20) corresponding to the radar Rx signals received by the Rx antenna array 2034 (FIG. 20) based on the radar Tx signals from the Tx antenna array 2032 (FIG. 20), e.g., as described above.

As indicated at block 2304, the method may include detecting whether the radar Rx signals are subject to an interference signal based on a first AoA spectrum and a second AoA spectrum, wherein the first AoA spectrum is based on AoA processing of the radar Rx data according to a virtual antenna including a convolution of the Rx antenna array and the Tx antenna array, wherein the second AoA spectrum is based on a plurality of sub-array AoA spectrums corresponding to a respective plurality of Rx antenna sub-arrays of the Rx antenna array. For example, a sub-array AoA spectrum corresponding to an Rx antenna sub-array may be based on AoA processing of radar Rx data corresponding to Rx signals received via the Rx antenna sub-array. For example, processor 2040 (FIG. 20) may be configured to detect whether the radar Rx signals are subject to the interference signal based on AoA spectrum 2230 (FIG. 22) and AoA spectrum 2240 (FIG. 22), e.g., as described above.

As indicated at block 2306, the method may include outputting detection information to identify the interference signal. For example, processor 2040 (FIG. 20) may be configured to cause output 2046 (FIG. 20) to output the detection information 2045 (FIG. 20), e.g., as described above.

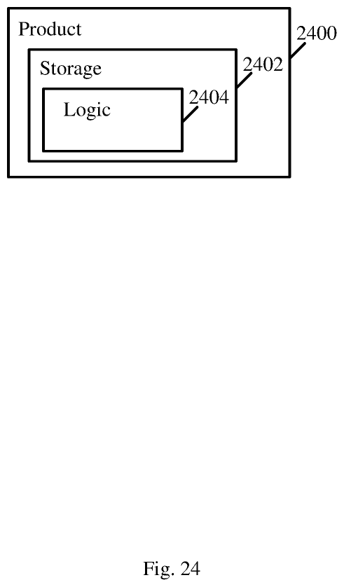

Reference is made to FIG. 24, which schematically illustrates a product of manufacture 2400, in accordance with some demonstrative aspects. Product 2400 may include one or more tangible computer-readable (“machine-readable”) non-transitory storage media 2402, which may include computer-executable instructions, e.g., implemented by logic 2404, operable to, when executed by at least one computer processor, enable the at least one computer processor to implement one or more operations and/or functionalities described with reference to the FIGS. 1, 2, 3, 4, 5, 6, 7, 8, 9, 10, 11, 12, 13, 14, 15, 16, 17, 18, 19, 20, 21, 22, and/or 23, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 2400 and/or storage media 2402 may include one or more types of computer-readable storage media capable of storing data, including volatile memory, non-volatile memory, removable or non-removable memory, erasable or non-erasable memory, writeable or re-writeable memory, and the like. For example, storage media 2402 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 2404 may include instructions, data, and/or code, which, if executed by a machine, may cause the machine to perform a method, process, and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 2404 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner, or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### Examples

The following examples pertain to further aspects.

Example 1 includes an apparatus comprising a processor configured to identify a value of an interference-based parameter corresponding to an interference level in an environment of a radar device; based on the value of the interference-based parameter, determine a Point Cloud (PC) dimension size of at least one dimension of a four-dimension (4D) PC; generate 4D PC radar information according to the PC dimension size, the 4D PC radar information based on radar data corresponding to radar signals communicated by the radar device; and an output to provide the 4D PC radar information.

Example 2 includes the subject matter of Example 1, and optionally, wherein the PC dimension size of the dimension of the 4D PC comprises a reduced PC dimension size, which is less than a supported size of the dimension of the 4D PC.

Example 3 includes the subject matter of Example 2, and optionally, wherein the reduced PC dimension size is to define a selected sub-range of dimension values from a range of dimension values in the dimension of the 4D PC, the processor to generate the 4D PC radar information with respect to the sub-range of dimension values.

Example 4 includes the subject matter of any one of Examples 1-3, and optionally, wherein the processor is configured to determine a first PC dimension size based on a first value of the interference-based parameter, to generate first 4D PC radar information according to the first PC dimension size, to determine a second PC dimension size based on a second value of the interference-based parameter, and to generate second 4D PC radar information according to the second PC dimension size, wherein the first value of the interference-based parameter is different from the second value of the interference-based parameter, the first PC dimension size defining a first sub-range of dimension values from a range of dimension values in the dimension of the 4D PC, the second PC dimension size defining a second sub-range of dimension values from the range of dimension values in the dimension of the 4D PC, the second sub-range of dimension values different from the first sub-range of dimension values.

Example 5 includes the subject matter of Example 4, and optionally, wherein the first value of the interference-based parameter is greater than the second value of the interference-based parameter, and the second PC dimension size is less than the first PC dimension size.

Example 6 includes the subject matter of any one of Examples 1-5, and optionally, wherein the processor is configured to determine a radar scheme based on the value of the interference-based parameter, the radar scheme to define a configuration of the radar device to generate the 4D PC radar information according to the PC dimension size.

Example 7 includes the subject matter of Example 6, and optionally, wherein the radar scheme comprises a radar communication scheme to communicate the radar signals, the radar communication scheme according to the PC dimension size.

Example 8 includes the subject matter of Example 7, and optionally, wherein the radar communication scheme comprises a radar Transmission (Tx) scheme to configure transmission of radar Tx signals by the radar device.

Example 9 includes the subject matter of Example 8, and optionally, wherein the radar Tx scheme comprises a Tx beamforming scheme.

Example 10 includes the subject matter of Example 8 or 9, and optionally, wherein the radar Tx scheme comprises a Tx frequency bandwidth (BW) for transmission of the radar Tx signals.

Example 11 includes the subject matter of any one of Examples 8-10, and optionally, wherein the radar Tx scheme comprises at least one of a Tx pulse duration of the radar Tx signals, or a count of Tx pulses per radar frame.

Example 12 includes the subject matter of any one of Examples 7-11, and optionally, wherein the radar communication scheme comprises a radar frame rate according to the PC dimension size, the radar frame rate to configure a rate of radar frames to be communicated by the radar device.

Example 13 includes the subject matter of any one of Examples 7-12, and optionally, wherein the radar communication scheme comprises a radar range to configure a maximal radar detection range.

Example 14 includes the subject matter of any one of Examples 7-13, and optionally, wherein the radar scheme comprises a radar processing scheme to process the radar data corresponding to radar signals communicated by the radar device, the radar processing scheme according to the PC dimension size.

Example 15 includes the subject matter of Example 11, and optionally, wherein the radar processing scheme comprises a multi-snapshot processing scheme to configure a count of radar snapshots to process the radar data corresponding to the radar signals communicated by the radar device.

Example 16 includes the subject matter of any one of Examples 1-15, and optionally, wherein the processor is configured to determine a selected radar scheme from a plurality of radar schemes based on the value of the interference-based parameter, the selected radar scheme corresponding to the PC dimension size.

Example 17 includes the subject matter of any one of Examples 1-16, and optionally, wherein the processor is configured to adjust the PC dimension size based on a comparison between the value of the interference-based parameter and a threshold value.

Example 18 includes the subject matter of any one of Examples 1-17, and optionally, wherein the processor is configured to monitor the value of the interference-based parameter, and to dynamically adjust the PC dimension size based on a detected change in the value of the interference-based parameter.

Example 19 includes the subject matter of any one of Examples 1-18, and optionally, wherein the processor is configured to negotiate the PC dimension size with a system controller of a system comprising the radar device.

Example 20 includes the subject matter of any one of Examples 1-19, and optionally, wherein the PC dimension size comprises a size of an azimuth Field of View (FoV) in the 4D PC.

Example 21 includes the subject matter of any one of Examples 1-20, and optionally, wherein the PC dimension size comprises a size of an elevation Field of View (FoV) in the 4D PC.

Example 22 includes the subject matter of any one of Examples 1-21, and optionally, wherein the PC dimension size comprises a size of a range dimension in the 4D PC.

Example 23 includes the subject matter of any one of Examples 1-22, and optionally, wherein the PC dimension size comprises a size of a Doppler dimension in the 4D PC.

Example 24 includes the subject matter of any one of Examples 1-23, and optionally, wherein the processor is configured to identify a selected radio resource from a plurality of radio resources to communicate the radar signals, and to determine the PC dimension size based on the value of the interference-based parameter corresponding to the selected radio resource.

Example 25 includes the subject matter of any one of Examples 1-24, and optionally, wherein the interference-based parameter is based on a Signal-to-Interference-Noise (SINR) estimation corresponding to a radar radio resource for communication of the radar signals.

Example 26 includes the subject matter of any one of Examples 1-25, and optionally, comprising the radar device to communicate the radar signals, and to generate radar information based on the 4D PC radar information.

Example 27 includes the subject matter of Example 26, and optionally, comprising a vehicle, the vehicle comprising a system controller to control one or more systems of the vehicle based on the radar information.

Example 28 includes an apparatus comprising a processor configured to determine a setting of one or more Transmit (Tx) parameters, the setting of the one or more Tx parameters to configure Tx radar signals to be transmitted by a transmitter of a radar device, wherein the processor is configured to adjust the setting of the one or more Tx parameters from a first Tx parameter setting to a second Tx parameter setting based on an interference Tx parameter estimation corresponding to the one or more Tx parameters, the interference Tx parameter estimation corresponding to an interferer in an environment of the radar device, wherein the processor is configured to determine the second Tx parameter setting such that a correlation between the second Tx parameter setting and the interference Tx parameter estimation is greater than a correlation between the first Tx parameter setting and the interference Tx parameter estimation; and an output to provide Tx parameter information for the transmitter of the radar device, the Tx parameter information based on the setting of one or more Tx parameters.

In one example, the apparatus of Example 28 may include, for example, one or more additional elements, and/or may perform one or more additional operations and/or functionalities, for example, as described with respect to Examples 1 and/or 42.

Example 29 includes the subject matter of Example 28, and optionally, wherein the interference Tx parameter estimation is based on Receive (Rx) radar signals, the Rx radar signals received by the radar device based on first Tx radar signals transmitted by the transmitter according to the first Tx parameter setting, the processor configured to determine the second Tx parameter setting to configure second Tx radar signals to be transmitted by the transmitter subsequent to the first Tx signals.

Example 30 includes the subject matter of Example 28 or 29, and optionally, wherein the processor is configured to determine the second Tx parameter setting to provide a radar detection result having a noise floor, which is lower than a noise floor according to the first Tx parameter setting, the radar detection result based on Tx radar signals transmitted by the transmitter according to the second Tx parameter setting.

Example 31 includes the subject matter of Example 30, and optionally, wherein the processor is configured to determine the interference Tx parameter estimation based on the noise floor according to the first Tx parameter setting.

Example 32 includes the subject matter of any one of Examples 28-31, and optionally, wherein the processor is configured to determine the second Tx parameter setting such that a detection corresponding to the interferer in a radar detection result is detectable as a non-valid detection, the radar detection result based on Tx radar signals transmitted by the transmitter according to the second Tx parameter setting.

Example 33 includes the subject matter of any one of Examples 28-32, and optionally, wherein the processor is configured to set the Tx parameter information to indicate a time shift to be introduced to a start time of a transmission of the Tx radar signals according to the second Tx parameter setting.

Example 34 includes the subject matter of any one of Examples 28-33, and optionally, wherein the one or more Tx parameters comprise at least one of a slope of a Tx radar signal, a bandwidth of the Tx radar signal, or a time duration of the Tx radar signal.

Example 35 includes the subject matter of any one of Examples 28-34, and optionally, wherein the one or more Tx parameters comprise at least one of a modulation type of a Tx radar signal, a Multiple-Input-Multiple-Output (MIMO) scheme, or a coding of the Tx radar signal.

Example 36 includes the subject matter of any one of Examples 28-35, and optionally, wherein the processor is configured to determine the second Tx parameter setting to have a correlation of at least 70% with the interference Tx parameter estimation.

Example 37 includes the subject matter of any one of Examples 28-36, and optionally, wherein the processor is configured to determine the second Tx parameter setting to have a correlation of at least 80% with the interference Tx parameter estimation.

Example 38 includes the subject matter of any one of Examples 28-37, and optionally, wherein the processor is configured to determine the second Tx parameter setting to have a correlation of at least 90% with the interference Tx parameter estimation.

Example 39 includes the subject matter of any one of Examples 28-38, and optionally, comprising a radar detector to determine a radar detection result based on the Tx radar signals transmitted by the transmitter of the radar device according to the second Tx parameter setting, the radar detector configured to determine that a detection in the radar detection result corresponding to the interferer is a non-valid detection.

Example 40 includes the subject matter of any one of Examples 28-39, and optionally, comprising the radar device, the radar device configured to generate radar information based on the Tx radar signals.

Example 41 includes the subject matter of Example 40, and optionally, comprising a vehicle, the vehicle comprising a system controller to control one or more systems of the vehicle based on the radar information.

Example 42 includes an apparatus comprising an input to receive radar Receive (Rx) data corresponding to radar Rx signals received by an Rx antenna array based on radar Transmit (Tx) signals from a Tx antenna array; and a processor configured to detect whether the radar Rx signals are subject to an interference signal based on a first Angle-of-Arrival (AoA) spectrum and a second AoA spectrum, wherein the first AoA spectrum is based on AoA processing of the radar Rx data according to a virtual antenna comprising a convolution of the Rx antenna array and the Tx antenna array, wherein the second AoA spectrum is based on a plurality of sub-array AoA spectrums corresponding to a respective plurality of Rx antenna sub-arrays of the Rx antenna array, a sub-array AoA spectrum corresponding to an Rx antenna sub-array is based on AoA processing of radar Rx data corresponding to Rx signals received via the Rx antenna sub-array.

In one example, the apparatus of Example 42 may include, for example, one or more additional elements, and/or may perform one or more additional operations and/or functionalities, for example, as described with respect to Examples 1 and/or 28.

Example 43 includes the subject matter of Example 42, and optionally, wherein the processor is configured to detect the interference signal based on a comparison between the first AoA spectrum and the second AoA spectrum.

Example 44 includes the subject matter of Example 42 or 43, and optionally, wherein the processor is configured to detect the interference signal based on a comparison between one or more first peaks above a threshold in the first AoA spectrum and one or more second peaks above the threshold in the second AoA spectrum.

Example 45 includes the subject matter of any one of Examples 42-44, and optionally, wherein the processor is configured to detect the interference signal based on a comparison between a first peak count and a second peak count, the first peak count comprising a count of one or more first peaks above a threshold in the first AoA spectrum, the second peak count comprising a count of one or more second peaks above the threshold in the second AoA spectrum.

Example 46 includes the subject matter of any one of Examples 42-45, and optionally, wherein the processor is configured to detect the interference signal based on a determination that a first peak count is different from a second peak count, the first peak count comprising a count of one or more first peaks above a threshold in the first AoA spectrum, the second peak count comprising a count of one or more second peaks above the threshold in the second AoA spectrum.

Example 47 includes the subject matter of any one of Examples 42-46, and optionally, wherein the processor is configured to identify a possible valid detection to be at an angle corresponding to a highest peak of all peaks in the first AoA spectrum and the second AoA spectrum.

Example 48 includes the subject matter of any one of Examples 42-47, and optionally, wherein the processor is configured to identify the interference signal to be at an angle corresponding to a peak, which appears in the second AoA spectrum and does not appear in the first AoA spectrum.

Example 49 includes the subject matter of any one of Examples 42-48, and optionally, wherein the processor is configured to determine the second AoA spectrum based on a combination of the plurality of sub-array AoA spectrums.

Example 50 includes the subject matter of any one of Examples 42-49, and optionally, wherein the virtual antenna comprising the convolution of the Rx antenna array and the Tx antenna array comprises a Uniform Linear Array (ULA).

Example 51 includes the subject matter of any one of Examples 42-50, and optionally, wherein the Rx antenna sub-array comprises a Uniform Linear Array (ULA).

Example 52 includes the subject matter of any one of Examples 42-51, and optionally, wherein the interference signal comprises a spoofing signal from a radar spoofer.

Example 53 includes the subject matter of any one of Examples 42-52, and optionally, comprising an output to provide detection information to identify the interference signal.

Example 54 includes the subject matter of any one of Examples 42-53, and optionally, comprising a radar processor configured to generate radar information based on the radar Rx data.

Example 55 includes the subject matter of Example 54, and optionally, comprising a vehicle, the vehicle comprising a system controller to control one or more systems of the vehicle based on the radar information.

Example 56 includes a radar device comprising one or more of the apparatuses of Examples 1-55.

Example 57 includes a vehicle comprising one or more of the apparatuses of Examples 1-55.

Example 58 includes an apparatus comprising means for executing any of the described operations of Examples 1-55.

Example 59 includes a machine-readable medium that stores instructions for execution by a processor to perform any of the described operations of Examples 1-55.

Example 60 includes an apparatus comprising a memory; and processing circuitry configured to perform any of the described operations of Examples 1-55.

Example 61 includes a method including any of the described operations of Examples 1-55.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1-30. (canceled)

31. An apparatus comprising:
a processor configured to:
identify a value of an interference-based parameter corresponding to an interference level in an environment of a radar device;
based on the value of the interference-based parameter, determine a Point Cloud (PC) dimension size of at least one dimension of a four-dimension (4D) PC;
generate 4D PC radar information according to the PC dimension size, the 4D PC radar information based on radar data corresponding to radar signals communicated by the radar device; and
an output to provide the 4D PC radar information.

32. The apparatus of claim 31, wherein the PC dimension size of the dimension of the 4D PC comprises a reduced PC dimension size that is less than a supported size of the dimension of the 4D PC.

33. The apparatus of claim 32, wherein the reduced PC dimension size defines a selected sub-range of dimension values from a range of dimension values in the dimension of the 4D PC, wherein the processor is configured to generate the 4D PC radar information with respect to the sub-range of dimension values.

34. The apparatus of claim 31, wherein the processor is configured to:
determine a first PC dimension size based on a first value of the interference-based parameter;
generate first 4D PC radar information according to the first PC dimension size;
determine a second PC dimension size based on a second value of the interference-based parameter; and
generate second 4D PC radar information according to the second PC dimension size, wherein the first value of the interference-based parameter is different from the second value of the interference-based parameter,
wherein the first PC dimension size defines a first sub-range of dimension values from a range of dimension values in the dimension of the 4D PC,
wherein the second PC dimension size defines a second sub-range of dimension values from the range of dimension values in the dimension of the 4D PC,
wherein the second sub-range of dimension values are different from the first sub-range of dimension values.

35. The apparatus of claim 34, wherein the first value of the interference-based parameter is greater than the second value of the interference-based parameter, and the second PC dimension size is less than the first PC dimension size.

36. The apparatus of claim 31, wherein the processor is configured to determine a radar scheme based on the value of the interference-based parameter, wherein the radar scheme defines a configuration of the radar device to generate the 4D PC radar information according to the PC dimension size.

37. The apparatus of claim 36, wherein the radar scheme comprises a radar communication scheme to communicate the radar signals, wherein the radar communication scheme is according to the PC dimension size.

38. The apparatus of claim 37, wherein the radar communication scheme comprises a radar Transmission (Tx) scheme to configure transmission of radar Tx signals by the radar device.

39. The apparatus of claim 38, wherein the radar Tx scheme comprises at least one of a Tx beamforming scheme, a Tx frequency bandwidth (BW) for transmission of the radar Tx signals, a Tx pulse duration of the radar Tx signals, or a count of Tx pulses per radar frame.

40. The apparatus of claim 37, wherein the radar communication scheme comprises a radar frame rate according to the PC dimension size, wherein the radar frame rate configures a rate of radar frames to be communicated by the radar device.

41. The apparatus of claim 37, wherein the radar communication scheme comprises a radar range to configure a maximal radar detection range.

42. The apparatus of claim 36, wherein the radar scheme comprises a radar processing scheme to process the radar data corresponding to radar signals communicated by the radar device, wherein the radar processing scheme is according to the PC dimension size.

43. The apparatus of claim 42, wherein the radar processing scheme comprises a multi-snapshot processing scheme to configure a count of radar snapshots to process the radar data corresponding to the radar signals communicated by the radar device.

44. The apparatus of claim 31, wherein the processor is configured to adjust the PC dimension size based on a comparison between the value of the interference-based parameter and a threshold value.

45. The apparatus of claim 31, wherein the processor is configured to monitor the value of the interference-based parameter, and to adjust the PC dimension size based on a detected change in the value of the interference-based parameter.

46. The apparatus of claim 31, wherein the processor is configured to negotiate the PC dimension size with a system controller of a system comprising the radar device.

47. The apparatus of claim 31, wherein the PC dimension size comprises at least one of a size of an azimuth Field of View (FoV) in the 4D PC, a size of an elevation Field of View (FoV) in the 4D PC, a size of a range dimension in the 4D PC, or a size of a Doppler dimension in the 4D PC.

48. The apparatus of claim 31, wherein the processor is configured to identify a selected radio resource from a plurality of radio resources to communicate the radar signals, and to determine the PC dimension size based on the value of the interference-based parameter corresponding to the selected radio resource.

49. The apparatus of claim 31 comprising a transmitter to transmit (Tx) radar Tx signals, and a receiver to receive (Rx) radar Rx signals based on the radar Tx signals, wherein the radar data is based on the radar Rx signals.

50. A product comprising one or more tangible computer-readable non-transitory storage media comprising instructions operable to, when executed by at least one processor, enable the at least one processor to:
identify a value of an interference-based parameter corresponding to an interference level in an environment of a radar device;
based on the value of the interference-based parameter, determine a Point Cloud (PC) dimension size of at least one dimension of a four-dimension (4D) PC; and
generate 4D PC radar information according to the PC dimension size, the 4D PC radar information based on radar data corresponding to radar signals communicated by the radar device.

51. The product of claim 50, wherein the instructions, when executed, cause the processor to adjust the PC dimension size based on at least one of a comparison between the value of the interference-based parameter and a threshold value, or a detected change in the value of the interference-based parameter.

52. A vehicle comprising:
a system controller configured to control one or more vehicular systems of the vehicle based on radar information; and
a radar system configured to provide the radar information to the system controller, the radar system comprising:
a plurality of Transmit (Tx) antennas to transmit radar Tx signals;
a plurality of Receive (Rx) antennas to receive radar Rx signals based on the radar Tx signals; and
a processor configured to:
identify a value of an interference-based parameter corresponding to an interference level in an environment of the radar system;
based on the value of the interference-based parameter, determine a Point Cloud (PC) dimension size of at least one dimension of a four-dimension (4D) PC; and
generate 4D PC radar information according to the PC dimension size, the 4D PC radar information is based on radar data corresponding to the radar Rx signals, wherein the radar information provided by the radar system is based on the 4D PC radar information.

53. The vehicle of claim 52, wherein the processor is configured to negotiate the PC dimension size with the system controller.
